(19) United States
(12) Patent Application Publication
(10) Pub. No.: US 2006/0290775 A1
(43) Pub. Date: Dec. 28, 2006

(54) PROGRAM EXECUTION APPARATUS AND EXECUTION METHOD

(75) Inventors: Yuki HORII, Osaka, NJ (JP); Shigeaki WATANABE, Osaka, NJ (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/425,727

(22) Filed: Jun. 22, 2006

Related U.S. Application Data
(60) Provisional application No. 60/693,040, filed on Jun. 23, 2005.

(51) Int. Cl. H04N 7/14

(52) U.S. Cl. 348/14.01

(57) ABSTRACT

A broadcast receiving apparatus which receives and reproduces broadcasts of plural broadcasting systems uses, in parallel, reproduction environments of the plural broadcasting systems, determines the broadcasting system to which a specified channel belongs at the time when a user selects the channel and switches the reproduction environment for reproducing the channel to the reproduction environment of the broadcasting system. Further, the broadcast receiving apparatus determines the reproduction environment of the broadcasting system to which the currently being reproduced channel belongs at the time when a key input is delivered from the user and switches a delivery destination of the key input to the reproduction environment of the broadcasting system.

### CROSS REFERENCE TO RELATED APPLICATION

This application claims the benefit of U.S. Provisional Application No. 60/693040, filed Jun. 23, 2005, the contents of which are herein incorporated by reference in its entirety.

### BACKGROUND OF THE INVENTION

(1) Field of the Invention

The present invention relates to a broadcast receiving apparatus which receives and reproduces contents included in a broadcast wave. In particular, the present invention relates to a broadcast receiving apparatus which receives and reproduces broadcast waves belonging to plural broadcasting systems.

(2) Description of the Related Art

A broadcast receiving apparatus, which receives and reproduces contents included in a broadcast wave belonging to a broadcasting system, has conventionally handled only a broadcast wave based on a single broadcasting system. Therefore, it is equipped with and makes use of only a reproduction environment of a single broadcasting system which receives and reproduces contents included in a broadcast wave.

Here, the reproduction environment of the broadcasting system is intended for receiving and reproducing the contents based on the specifications of a predetermined broadcasting system. It is configured by hardware, software and the like which receive and reproduce contents included in a broadcast wave. Accordingly, in order to receive and reproduce such contents based on predetermined specifications, a broadcast receiving apparatus needs to be provided with a reproduction environment of the broadcasting system based on the specifications, and receive and reproduce the contents using the reproduction environment.

Here, to use the reproduction environment means to initialize the hardware and activate the software which constitute the reproduction environment, and receive and reproduce the contents. For example, the following specifications are defined: the Digital Video Broadcasting-Multimedia Home Platform (DVB-MHP) ETSIES 201812V1.1.1 (2003-12) specifications and the like in a satellite broadcasting system; the Open Cable Application Platform (OCAP) OC-SP-OCAP 1.0-114-050119 specifications and the like in a cable broadcasting system; and the advanced Television Systems Committee (ATSC) specifications in a terrestrial wave broadcasting system.

However, in the case where broadcast waves belonging to plural broadcasting systems based on different specifications are broadcast in the same region, it is desirable that a single broadcast receiving apparatus can receive and reproduce contents included in the respective broadcast waves.

The Japanese Laid-Open Patent Application No. 2002-238003 provides an environment enabling a single broadcast receiving apparatus, which is equipped with reproduction environments for plural broadcasting systems, to receive and reproduce contents based on the different specifications.

The Japanese Laid-Open Patent Application No. 2002-238003 provides a mechanism enabling a single broadcast receiving apparatus, which is equipped with reproduction environments for plural broadcasting systems in order to receive and reproduce contents included in a broadcast wave belonging to the plural broadcasting systems, to selectively use the reproduction environments depending on the broadcasting system desired to be received and reproduced.

In the Japanese Laid-Open Patent Application No. 2002-238003, initialization of the hardware and activation of the software, which constitute the reproduction environments, are performed each time of switching the reproduction environments.

The OCAP specifications define a monitor application which is initially activated at the start of a reproduction environment use, and which is always activated while the reproduction environment is being used. For example, a channel switching application which is executed in reproduction environments of broadcasting systems based on the OCAP specifications can be such monitor application. Such channel switching application is initially activated when a reproduction environment starts to be executed, and which is always continuously executed during the execution of the reproduction environment.

According to the conventional technique described in the Japanese Laid-Open Patent Application No. 2002-238003, a broadcast receiving apparatus, which is equipped with reproduction environments of the broadcasting systems based on the plural specifications including the OCAP specifications, are implementable. In this case, the reproduction environments are selectively used when the channels of the OCAP specifications and other broadcasting system are switched. Therefore, a monitor application belonging to the broadcasting system based on the OCAP specifications needs to be terminated or executed each time when the reproduction environments are switched. Due to time lost during the activation of the monitor application, it is difficult to realize a smooth channel switching in this method.

In order to realize a smooth channel switching in this broadcast receiving apparatus, the need to terminate or execute the monitor application must be eliminated by realizing a state where the plural broadcasting systems based on the respective specifications are always available at the same time. In addition, there is a need to cause such apparatus to reproduce a channel specified by a user, using the reproduction environment of the broadcasting system corresponding to the channel.

However, the following requirements need to be satisfied in order to realize these.

First, there is a need for a mechanism which determines a broadcasting system to which a specified channel belongs when reproduction of the channel is specified by a user and switching a channel reproduction environment to the reproduction environment of the broadcasting system. In addition, there is a need for a mechanism which determines a broadcasting environment to which the currently being reproduced channel belongs when a key input is performed by a user, and switching a delivery destination of the key input to the reproduction environment of the broadcasting system.

For this, the present invention has been conceived. An object of the present invention is to provide a broadcasting content reproducing apparatus which is capable of performing a smooth channel switching, that is, a smooth content switching.

### SUMMARY OF THE INVENTION

In order to achieve the above-described object, the broadcast content reproducing apparatus, of the present invention, reproduces respective contents compliant with a plurality of broadcast specifications which are different from each other. The broadcast content reproducing apparatus includes: a plurality of reproduction environments which are ready, in parallel, to respectively reproduce the contents different from each other; a first reproduction environment identification unit which identifies a reproduction environment which is reproducing a content, from among the plurality of reproduction environments; and a delivery unit which delivers key input information indicating the details of an instruction to the reproduction environment identified by the first reproduction environment identification unit. In other words, the broadcasting content reproducing apparatus of the present invention executes in parallel reproduction environments of plural broadcasting systems, receives and reproduces broadcasts of the plurality of broadcasting systems. In the case where a key input is delivered from a user, the broadcasting content reproducing apparatus identifies the reproduction environment of the broadcasting system to which the currently being reproduced channel belongs, and switches the delivery destination of the key input to the reproduction environment of the broadcasting system.

In this way, the plurality of reproduction environments are in a state where they can be used in parallel. Therefore, even in the case where the reproduction environment which is reproducing a content is switched, there is no need to terminate the monitoring application and activate another one, and thus it is possible to eliminate time to be lost for terminating and activating these monitoring applications. In other words, it is possible to switch channels smoothly. Further, it is possible to accurately deliver key input information to the reproduction environment which is reproducing the content.

In addition, the broadcast content reproducing apparatus may further include: a selection unit which selects a content among the respective contents compliant with the plurality of broadcast specifications; a second reproduction environment identification unit which identifies a reproduction environment which is capable of reproducing the content selected by the selection unit, from among the plurality of reproduction environments; and a reproduction environment setting unit which causes the reproduction environment identified by the second reproduction environment determination unit to reproduce the content selected by the selection unit. In other words, the broadcasting content reproducing apparatus of the present invention executes in parallel reproduction environments of plural broadcasting systems, receives and reproduces broadcasts of the plural broadcasting systems. At the time when a user selects a channel, the broadcasting content reproducing apparatus identifies the reproduction environment of the broadcasting system to which the currently being reproduced channel belongs, and switches the reproduction environment which is reproducing the channel to the reproduction environment of the broadcasting system.

In this way, the plurality of reproduction environments are in a state where they can be used in parallel. Therefore, even in the case where a content among the contents is selected and the reproduction environment which is reproducing a content is switched, there is no need to terminate the monitoring application and activate another one, and thus it is possible to eliminate time to be lost for terminating and activating these monitoring applications. In other words, it is possible to switch channels smoothly. Further, it is possible to appropriately reproduce the content in the reproduction environment compliant with the broadcasting specifications for the selected content.

Note that the present invention can be realized not only as the above-described broadcast content reproducing apparatus, but also, for example, a broadcast content reproducing method, a program thereof, and a recording medium in which the program is stored.

As further information about technical background to this application, the disclosure of U.S. Provisional Application No. 60/693040 filed Jun. 23, 2005, including specification, drawings and claims, is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram of a broadcasting system;

FIG. 2 is a diagram showing an example of the use of the frequency band used for communication between the broadcasting station side system and the terminal apparatuses;

FIG. 3 is a diagram showing an example of the use of the frequency band used for communication between the broadcasting station side system and the terminal apparatuses;

FIG. 4 is a diagram showing an example of the use of the frequency band used for communication between the broadcasting station side system and the terminal apparatuses;

FIG. 5 is a configuration diagram of a TS packet prescribed in the MPEG-2 specifications;

FIG. 6 is a schematic diagram of the MPEG-2 transport stream;

FIG. 7 is a diagram showing a division example at the time when a PES packet prescribed in the MPEG-2 specifications is transmitted using TS packets;

FIG. 8 is a diagram showing a division example at the time when an MPEG-2 section prescribed in the MPEG-2 specifications is transmitted using TS packets;

FIG. 9 is a diagram showing a structure of the MPEG-2 section prescribed in the MPEG-2 specifications;

FIG. 10 is a diagram showing a use example of the MPEG-2 section prescribed in the MPEG-2 specifications;

FIG. 11 is a diagram showing a use example of a PMT prescribed in the MPEG-2 specifications;

FIG. 12 is a diagram showing a use example of a PAT prescribed in the MPEG-2 specifications;

FIG. 13 is a diagram showing a configuration example of the hardware configuration of the broadcast receiving apparatus (broadcast content reproducing apparatus);

FIG. 14 is a diagram showing an example of a front panel of the input unit of the terminal apparatus;

FIG. 15 is a conceptual diagram representing a physical connection sequence of the respective devices and the like at the time when a broadcast signal of the cable broadcasting system is received;

FIG. 16 is a conceptual diagram representing a physical connection sequence of the respective devices and the like at the time when a broadcast signal of the terrestrial wave broadcasting system is received;

FIG. 17 is a configuration diagram of a program in a broadcast receiving terminal where the cable television broadcasting system and the terrestrial wave broadcasting system coexist;

FIG. 18 is a diagram showing constituent elements provided with a library;

FIG. 19 is a diagram showing the internal structure of an AM;

FIG. 20 is a diagram showing an example of information held in a library;

FIG. 21 is a diagram showing a list of broadcasting system information held by a library;

FIG. 22 is a schematic diagram representing the contents of an AIT;

FIG. 23 is a schematic diagram representing a downloaded file system;

FIG. 24 is a diagram showing channel identifiers held by channel identifier holding units;

FIG. 25 is an example of a screen display for causing a user to select a TV show program;

FIG. 26 is an example of a screen display for causing a user to select a TV show program;

FIG. 27 is a flow chart indicating an example of processing at the time when a channel identifier identification unit receives a request for reproduction of a service;

FIG. 28 is a flow chart indicating an example of processing at the time when an event delivery unit receives a key input from a key input unit;

FIG. 29 is a diagram showing the structure of a program in the broadcast receiving terminal where the cable television broadcasting system and the terrestrial wave broadcasting system coexist;

FIG. 30 is a diagram showing a structure of a program in the broadcast receiving terminal where the cable television broadcasting system and the terrestrial wave broadcasting system coexist;

FIG. 31 is a diagram showing the internal structure of an event manager;

FIG. 32 is a diagram showing the internal structure of an AM;

FIG. 33 is a diagram schematically representing an example of XAIT information; and

FIG. 34 is a diagram representing an example of a state where the XAIT information and the file system are held in an associated manner.

### DESCRIPTION OF THE PREFERRED EMBODIMENT(S)

The present invention relates to a broadcast content reproducing apparatus which executes in parallel a plurality of reproduction environments for reproducing respective contents compliant with broadcast specifications different from each other. The broadcast content reproducing apparatus includes: a reproduction environment identification unit which identifies a reproduction environment for reproducing a selected content; a reproduction environment setting unit which reproduces the selected content in the reproduction environment, which has been identified by the reproduction environment identification unit, among the plurality of reproduction environments which are being executed; a current reproduction environment identification unit which identifies the reproduction environment to which a key input is delivered in accordance with the reproduction environment which is currently reproducing a TV show program content, at the time when a key input is delivered from a user; and a key input delivery unit which delivers the key input to the TV show program content which the reproduction environment, which has been identified by the current reproduction environment identification unit, is reproducing. The broadcast content reproducing apparatus is capable of seamlessly switching reproduction environments which reproduce TV show program contents compliant with difference specifications and delivering a key input to the reproduction environment by which the TV show program content is currently being reproduced.

### First Embodiment

An apparatus and a method of a first embodiment of the present invention will be described below with reference to the drawings. In this embodiment, an embodiment in the case of reproducing TV show program contents to be transmitted and received in a broadcasting system will be described. The present invention is subjected to reproduction of contents transmitted and received using an arbitrary medium. Conceivable broadcasting systems include: a satellite broadcasting system which is an embodiment of transmitting a broadcast signal to a broadcast reproducing apparatus using a satellite; a terrestrial wave broadcasting system which is an embodiment of transmitting a broadcast signal to a broadcast receiving apparatus using a terrestrial wave signal transmitting apparatus; a cable television broadcasting system which is an embodiment of transmitting a broadcast signal to a broadcasting receiving apparatus using a head end and the like. However, an embodiment where the cable television broadcasting system and the terrestrial wave broadcasting system coexist is described as an example in this embodiment. A broadcast receiving apparatus (broadcast content reproducing apparatus) of the present invention is generally called terminal apparatus.

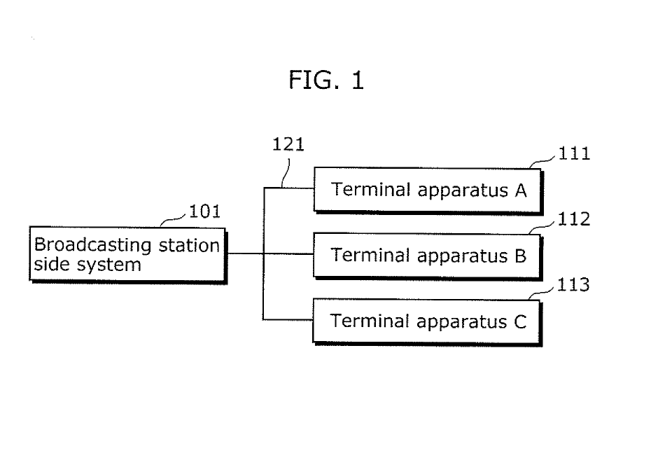

FIG. 1 is a block diagram showing a relationship between apparatuses which configure a broadcasting system; the broadcasting system is configured by a broadcasting station side system (head-end) 101, and three terminal apparatuses of a terminal apparatus A111, a terminal apparatus B112, and a terminal apparatus C113. A connection 121 between the broadcasting station side system and each of the terminal apparatus can be either wired or wireless. For example, in the cable broadcasting system, the broadcasting station side system and each of the terminal apparatuses are connected by wire. On the other hand, In the satellite and terrestrial systems, there is no wired connection between the broadcasting station side system and each of the terminal apparatuses in the out-bound direction (from the broadcasting station side system to each of the terminal apparatuses), and a broadcast signal is transmitted using radio waves. As for the in-bound direction (from each of the terminal apparatus to the broadcasting station side system), connections can be both a wired connection using such as a telephone line and the wired Internet and a wireless connection using wireless communication, and each of the terminal apparatuses transmits information such as user inputs to the broadcasting station side system. In FIG. 1, one broadcasting station side system is coupled with three terminal apparatuses, but the number of terminal apparatuses is arbitrary.

The broadcasting station side system 101 transmits information such as video, audio, data for data broadcast in a broadcast signal to a plurality of terminal apparatuses. The broadcast signal is transmitted using a frequency within a frequency band defined by the operational regulations of the broadcasting system, the laws of a country and a region in which the broadcasting system is operated, and so on.

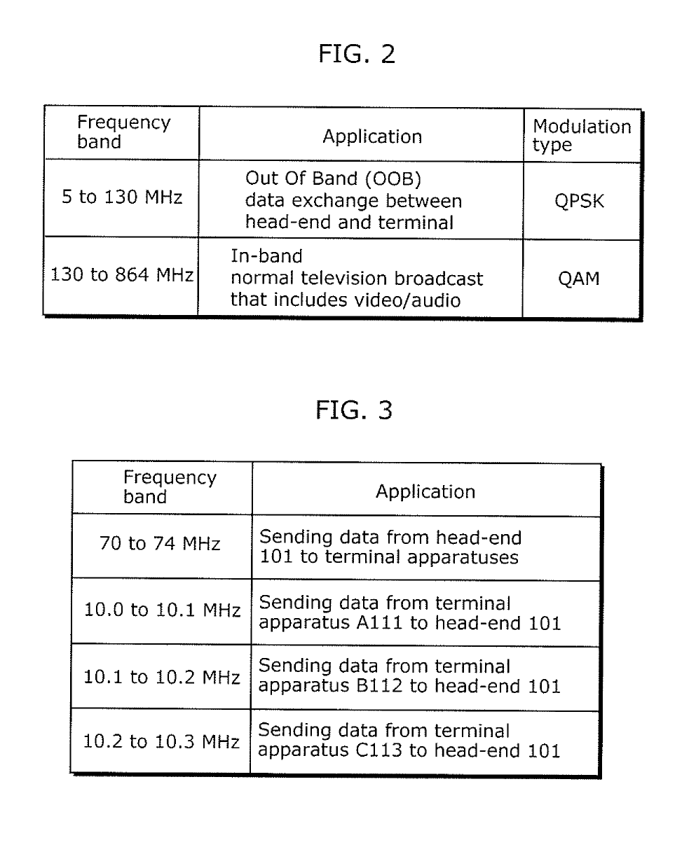

As an example, a broadcast signal transmission requirements concerning the cable broadcasting system is shown here. In the cable broadcasting system of this embodiment, the frequency band used in broadcast signal transmission is divided for each data to content and transmission direction (in-bound, out-bound) and the divided frequency bands are assigned thereto. FIG. 2 is a chart indicating one example of the division of the frequency band. The frequency band is roughly divided into two types: Out Of Band (abbr. OOB) and In-Band. 5 MHz to 130 MHz is assigned as OOB, and is mainly used in data exchange between the broadcasting station side system 101 and the terminal apparatus A111, the terminal apparatus B112, and the terminal apparatus C113 in both the in-bound and out-bound directions. 130 MHz to 864 MHz is assigned as In-Band, and is mainly used in an out-bound-only broadcast channel that includes video and audio. The QPSK modulation scheme is used with OOB, and the QAM 64 or the QAM 256 modulation scheme is used with In-Band. Modulation scheme technology is generally known and of little concern to the present invention, and therefore detailed description is omitted. 25 FIG. 3 is one example of a more detailed use of the OOB frequency band. 70 MHz to 74 MHz is used in out-bound data transmission from the broadcasting station side system 101, and all of the terminal apparatus A111, the terminal apparatus B112, and the terminal apparatus C113 receive the same data from the broadcasting station side system 101. On the other hand, 10.0 MHz to 10.1 MHz is used in in-bound data transmission from the terminal apparatus A111 to the broadcasting station side system 101; 10.1 MHz to 10.2 MHz is used in in-bound data transmission from the terminal apparatus B112 to the broadcasting station side system 101; and 10.2 MHz to 10.3 MHz is used in in-bound data transmission from the terminal apparatus C113 to the broadcasting station side system 101. Through this, it is possible to independently transmit unique data from each terminal apparatus A111, B112, and C113 to the broadcasting station side system 101.

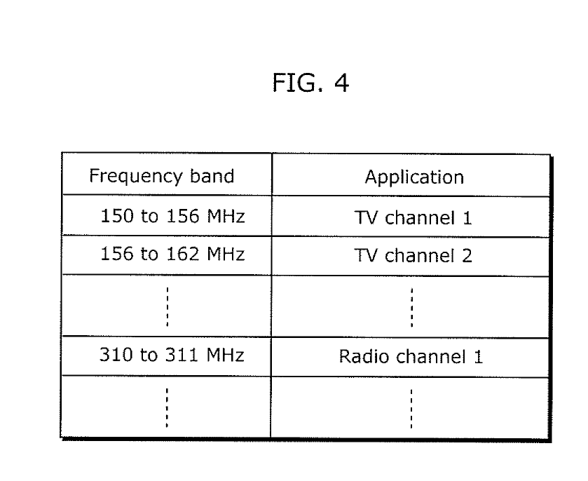

FIG. 4 is one example of use of the In-Band frequency band. 150 MHz to 156 MHz and 156 MHz to 162 MHz are assigned to a TV channel 1 and a TV channel 2 respectively, and thereafter, TV channels are assigned at 6 MHz intervals. Radio channels are assigned in 1 MHz units from 310 MHz on. Each of these channels may be used as analog broadcast or as digital broadcast. In the case of transmitting digital broadcast, a TS packet format based on the MPEG-2 specifications is used for the transmission, and it is also possible to transmit data for various data broadcast and TV show composition information for configuring an EPG, in addition to audio and video.

The broadcasting station side system 101 uses the frequency bands described above to transmit an appropriate broadcast signal to the terminal apparatuses, and therefore, has a QPSK modulation unit, a QAM modulation unit, and so on. In addition, the broadcasting station side system 101 has a QPSK demodulator for receiving data from the terminal apparatuses. Moreover, the broadcasting station side system 101 can be thought of as having various devices related to the modulation units and the demodulation unit. However, the present invention relates mainly to the terminal apparatuses, and therefore detailed descriptions are omitted.

Meanwhile, the terminal apparatuses A111, B112, and C113 have a QAM demodulation unit and a QPSK demodulation unit in order to receive and reproduce a broadcast signal from the broadcasting station side system 101. In addition, each terminal apparatus has a QSPK modulation unit in order to transmit the data unique to the apparatus to the broadcasting station system side 101. In the present invention, the terminal apparatuses are broadcast receiving apparatuses, and detailed configurations are described later.

The broadcasting station side system 101 modulates an IMPEG-2 transport stream and transmits the stream within the broadcast signal. Each of the terminal apparatuses receives the broadcast signal, demodulates the broadcast signal so as to reproduce the MPEG-2 transport stream, extracts necessary information wherefrom, and uses the extracted information. In order to describe a function of the devices present in the terminal apparatus and the connection structure, the structure of the MPEG-2 transport stream will be briefly described first.

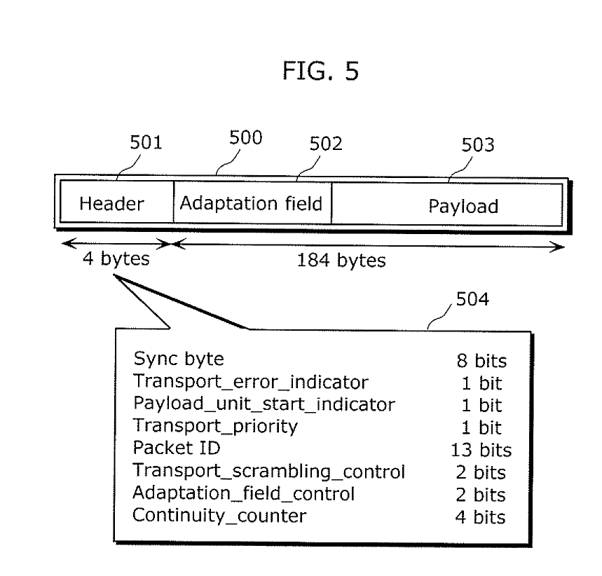

FIG. 5 is a diagram showing the structure of a TS packet. A TS packet 500 has a length of 188 bytes, and is composed of a header 501, an adaptation field 502, and a payload 503. The header 501 holds control information of the TS packet. The header 501 has a length of 4 bytes, and a structure presented by 504. It has a field denoted as “PacketID” (hereafter, PID), and the TS packet is identified based on the value of this PID. The adaptation field 502 holds additional information such as time information. The adaptation field 502 does not necessarily have to be present, and there are cases where the adaptation field 502 is not present. The payload 503 holds information transmitted by the TS packet, such as video, audio, and data broadcast data.

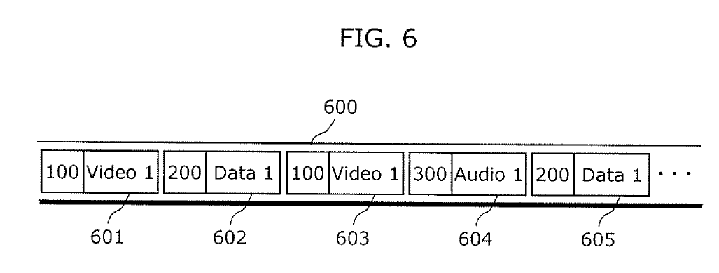

FIG. 6 is a schematic diagram of an MPEG-2 transport stream. The TS packet holds various information in the payload, such as video, audio, data used for data broadcast, and the like. A TS packet 601 and a TS packet 603 hold a PID 100 in the header, and hold information regarding video 1 in the payload. A TS packet 602 and a TS packet 605 hold a PID 200 in the header, and hold information regarding data 1 in the payload. A TS packet 604 holds a PID 300 in the header, and holds information regarding audio 1 in the payload. Mixing TS packets which hold various types of data in the payloads and transmitting these as a continuous sequence is called multiplexing. An MPEG-2 transport stream 600 is one example of a configuration in which the TS packets 601 to 605 are multiplexed.

TS packets with identical PIDs hold identical types of information. Therefore, the terminal apparatus reproduces video and audio, TV show composition information, by receiving the multiplexed TS packets and extracting, per PID, the information held by these TS packets. In FIG. 6, the TS packet 601 and the TS packet 603 each transmit information regarding the video 1, and the TS packet 602 and the TS packet 605 each transmit information regarding the data 1.

Here, description is given regarding formats of various types of data contained in the payloads. Video and audio are represented by a format called a Packetized Elementary Stream (PES) packet. The PES packet includes video information or audio information of a certain time period, and by receiving the PES packet, the broadcast receiving apparatus can output the video and audio information contained in that PES packet to a display screen and a speaker. The broadcast station transmits the PES packets continuously, and therefore it is possible for the broadcast receiving apparatus to continuously reproduce the video and audio without pause. When the PES packet is actually transmitted, the PES packet is divided and stored in the payloads of a plurality of TS packets, in the case where the PES packet has a size larger than the payload of one TS packet.

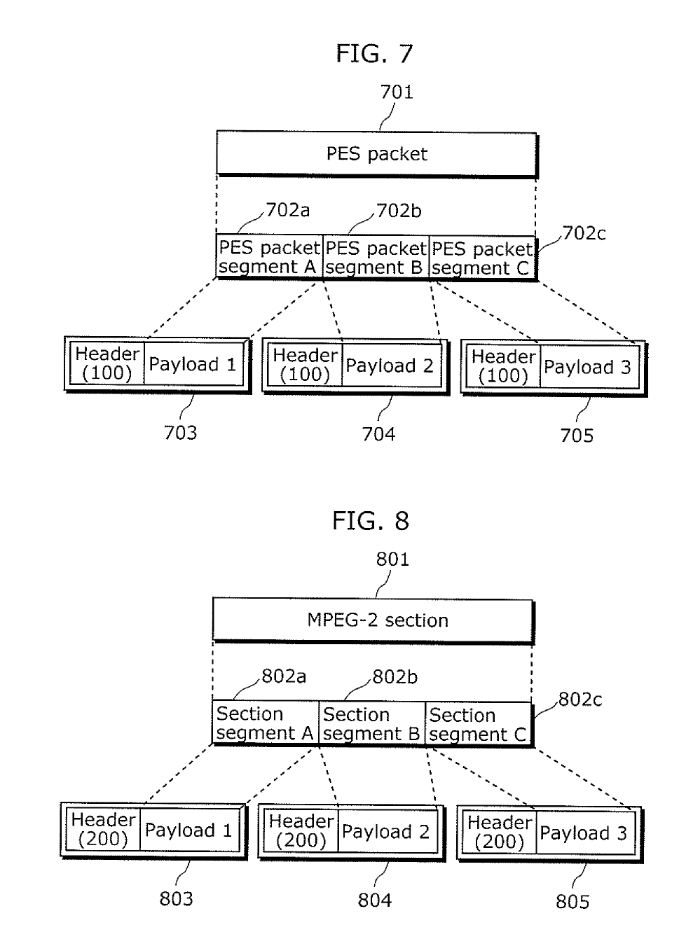

FIG. 7 shows an example of division when a PES packet is transmitted. A PES packet 701 is too large to be stored and transmitted in a payload of a single TS packet, and therefore the PES packet 701 is divided into a PES packet division A 702a, a PES packet division B 702b, and a PES packet division C 702c, and is transmitted by three TS packets 703 to 705 with identical PIDs. In reality, the video and audio are obtained as an elementary stream (ES) which is obtained by connecting data contained in the payloads of a plurality of PES packets. This elementary stream is in the form of digitalized video and audio, defined by the MPEG-2 Video standard, the MPEG-1 and 2 Audio standards, and the like.

On the other hand, TV show composition information and data used for data broadcast are represented using a format called MPEG-2 section. When the MPEG-2 section is actually transmitted, the MPEG-2 section is divided and stored in the payloads of a plurality of TS packets, in the case where the MPEG-2 section has a size larger than the payload of one TS packet. FIG. 8 shows an example of the division when the MPEG-2 section is transmitted. As an MPEG-2 section 801 is too large to be stored and transmitted in a payload of a single TS packet, the MPEG-2 section 801 is divided into a section segment A 802a, a section segment B 802b, and a section segment C 802c, and the divided section segments are transmitted by three TS packets 803 to 805 with identical PIDs.

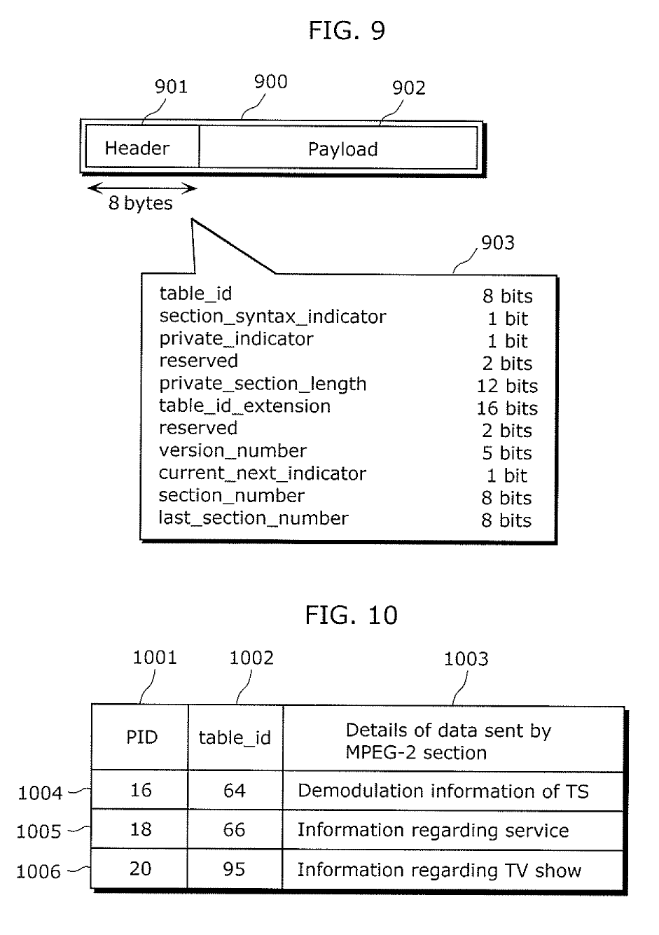

FIG. 9 represents a structure of such MPEG-2 section. An MPEG-2 section 900 is structured by a header 901 and a payload 902. The header 901 holds control information of the MPEG-2 section. That structure of the header 901 is represented by a header structure 903. The payload 902 holds data transmitted by the MPEG-2 section 900. A table_id present in the header configuration 903 represents the type of MPEG-2 section, and a table_id_extension is an extension identifier used when further distinguishing between MPEG-2 sections with an identical table_id. The case of transmitting the TV show composition information is shown in FIG. 10 as an example of use of the MPEG-2 section. In this example, as written in a line 1004, information necessary for demodulating the broadcast signal is written in the MPEG-2 section which has a table_id of 64 in the header structure 903, and this MPEG-2 section is further transmitted by a TS packet with a PID of 16.

The PES format does not exist in the case of the MPEG-2 section. For that reason, the elementary stream (ES) is a connection of the payloads of the TS packets identified by the identical PIDs within the MPEG-2 transport stream. For example, in FIG. 8, all of the TS packets 803 to 805, in which the MPEG-2 section 801 is divided and transmitted, are identified with the PID of 200. It can be said that this is an ES which transmits the MPEG-2 section 801.

A concept called program further exists in the MPEG-2 transport stream. The program is expressed as a collection of ESs, and is used in the case where a plurality of ESs are desired to be handled all together. With the use of the program, it is possible to handle video and audio, as well as accompanying data and broadcast data, all together. For example, in the case of handling together the video and audio which are desired to be reproduced in parallel, it can be seen that the broadcast receiving apparatus should reproduce in parallel two of the video ES and the audio ES as one program by grouping these ESs as a program.

To represent the program, two tables, called Program Map Table (PMT) and a Program Association Table (PAT) are used in MPEG-2. For detailed descriptions, refer to the specifications of the ISO/IEC 13818-1, and the “MPEG-2 Systems”. The PMT and the PAT are briefly described below.

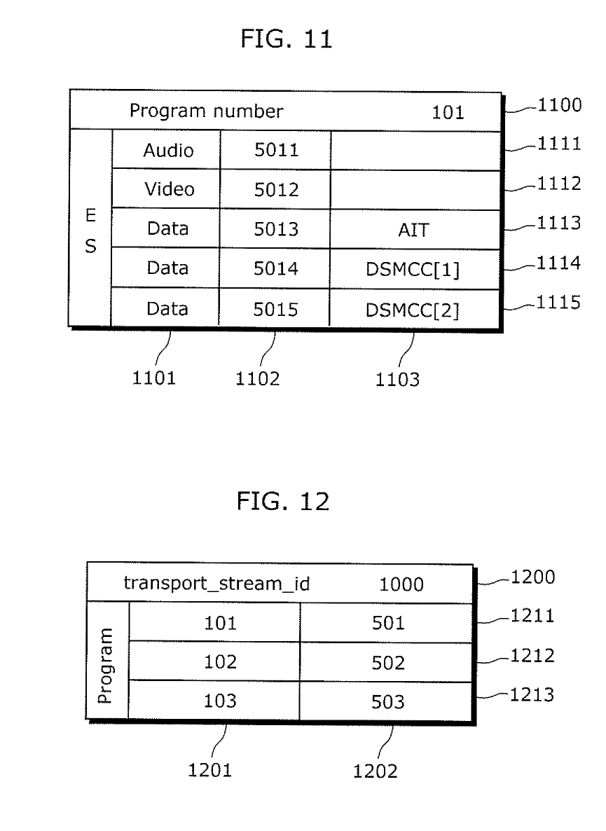

The PMT is a table included in the MPEG-2 transport stream, in a number as many as that of the programs. The PMT is structured as an MPEG-2 section, and has a table_id of 2. The PMT holds a program number used in identifying the program and additional information of the program, as well as information regarding an ES belonging to the program. An example of the PMT is given in FIG. 11. 1100 is a program number. The program number is assigned uniquely to programs in the same transport stream, and is used in identifying the PMT. Lines 1111 to 1114 represent information regarding individual ESs. A column 1101 is a type of ES, in which “video,” “audio,” “data,” and so on are specified. A column 1102 is the PID of the TS packets which configure the ES. A column 1103 is additional information regarding the ES. For example, the ES shown in the line 1111 is an audio ES, and is transmitted by the TS packets with a PID of 5011.

The PAT is a table which is uniquely present in the MPEG-2 transport stream. The PAT is structured as an MPEG-2 section, has a table_id of 0, and is transmitted by the TS packet with a PID of 0. The PAT holds a transport_stream_id used in identification of the MPEG-2 transport stream, and information regarding all the PMTs which represent a program in the MPEG-2 transport stream. An example of the PAT is provided in FIG. 12. 1200 is a transport_stream_id. The transport_stream_id is used in identifying the MPEG-2 transport stream. Lines 1211 to 1213 express information regarding the program. A column 1201 indicates a program number. A column 1202 indicates the PID of the TS packet which transmits the PMT corresponding to the program. For example, the PMT of the program shown in the line 1211 has a program number of 101, and the corresponding PMT is transmitted by the TS packet with a PID of 501.

In the case where the terminal apparatus reproduces a certain program, the terminal apparatus specifies the video and audio which configures a program with reference to the PAT and the PMT, and reproduces that video and audio. For example, in regards to the MPEG-2 transport stream which transmits the PAT in FIG. 12 and the PMT in FIG. 11, the following procedure is taken in the case where the video and audio belonging to the program with a program number of 101 are reproduced. First, a PAT transmitted as an MPEG-2 section with a table_id of “0” is obtained from a TS packet with a PID of “0.” A program with the program number “101 is searched based on the PAT, and the line 1211 is obtained. From the line 1211, the PID “501” of the TS packet which transmits the PMT of the program with a program number “101,” is obtained. Next, the PMT transmitted as the MPEG-2 section with a table_id of “2” is obtained from the TS packet with the PID of “501.” The line 1111 which is audio ES information and the line 1112 which is video ES information are obtained from the PMT. A PID “5011” of the TS packet which transmits the audio ES is obtained from the line 1111. In addition, a PID “5012” of the TS packet which transmits the video ES is obtained from the line 1112.

Next, an audio PES packet is obtained from the TS packet with a PID “5011,” and a video PES packet is obtained from the TS packet with a PID of “5012.” Through this, it is possible to obtain the video and audio ES packets to be reproduced, and the video and audio which configures the program number 101 can be reproduced.

Note that there are cases where the MPEG-2 transport stream is scrambled. This is a mechanism called conditional access system. For example, by scrambling the PES packets which transmit certain video and audio information, it becomes possible to allow only specified viewers who can descramble them to view that video and audio information. In order to descramble them and view the video and audio, a viewer must descramble them using a device called descrambler. For example, in an OCAP-compliant terminal apparatus, a card-type adapter with a built-in descrambler is used. A cable television operator delivers an adapter which has been set to be able to descramble a specified program to each viewer, and the viewer inserts that adapter into the terminal apparatus. Upon doing so, the adapter descrambles them for the specific program based on descrambling information such as a descrambling key and contract information of each contract holder. A method of descrambling, a method of obtaining the descrambling key, and the like depend on the adapter, and have no influence on the realization of the present invention.

A broadcast signal in the terrestrial wave broadcasting system is transmitted in a form of TS packets based on the MPEG-2 specifications similar to the above-mentioned cable broadcasting system. Accordingly, a terminal apparatus having a hardware configuration similar to the one in the cable broadcasting system can receive a broadcasting signal of the terrestrial wave broadcasting system.

It is assumed in the present invention that the terminal apparatus receives broadcast signals of both the cable broadcasting system and the terrestrial wave broadcasting system, and the broadcasting signals of both the cable broadcasting system and the terrestrial wave broadcasting system can be received and reproduced by a common hardware configuration. However, it is assumed that the broadcasting signal of the terrestrial wave broadcasting system is not scrambled. Hence, it is unnecessary to use an adapter in a hardware configuration in the case of receiving a broadcast signal of the terrestrial wave broadcasting system.

A hardware connection at the time of receiving broadcast signals of the cable broadcasting system and the terrestrial wave broadcasting system will be described later on.

Thus far, the MPEG-2 specifications have been briefly described, and hereafter, terminology is defined in detail. In the present invention, two types of the term “program” exist. One is a “program” which appears in the MPEG-2 specifications, and the other is a “program” referring to an assemblage of code executed by a CPU. As the former is synonymous with the term “service” used in the operation regulations, hereafter, to avoid confusion, the former is called “service” and the latter is called simply “program”. Furthermore, concerning the latter, a “program” particularly written in the Java language is called a “Java program”.

Several kinds of general information specified in the MPEG-2 specifications according to the present invention have been described above. Hereafter, the broadcast receiving terminal used in the present embodiment is described in detail.

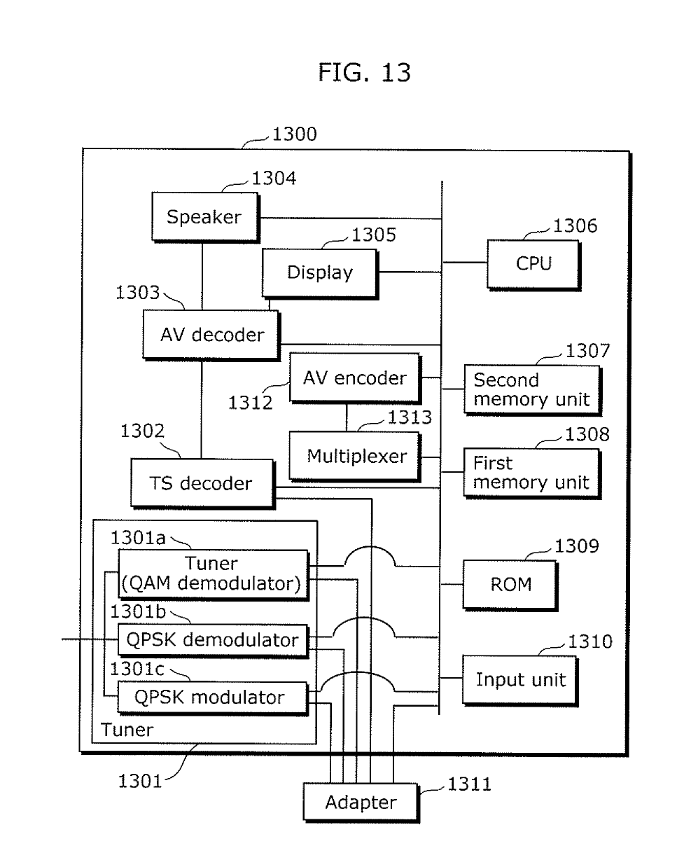

FIG. 13 is a block diagram showing a general hardware configuration of the broadcast receiving apparatus (broadcast content reproducing apparatus) of this embodiment; in other words, a specific internal configuration of the terminal apparatuses 111, 112, and 113 shown in FIG. 1. 1300 is the broadcast receiving apparatus, which is configured by: a tuner 1301; a TS decoder (TS Demultiplexer) 1302; an AV decoder 1303; a speaker 1304; a display 1305; a CPU 1306; a second memory unit 1307; a first memory unit 1308; a ROM 1309; an input unit 1310; and an adapter 1311. Note that the present embodiment is obtained by expanding a broadcast receiving terminal realized by the OCAP/OCAP-DVR specifications, and the basic hardware configuration is nearly identical to that required by the OCAP/OCAP-DVR specifications.

The tuner 1301 is a device which demodulates a broadcast signal modulated and transmitted from the broadcast station side system 101, in accordance with tuning information including a frequency prescribed by the CPU 1306. It is assumed that in this embodiment that a single tuner 1301 can demodulate both the cable broadcast and the terrestrial wave broadcast by setting proper modulation and demodulation parameters for the tuner 1301.

In the case where a broadcast signal of the cable broadcasting system is received, an MPEG-2 transport stream obtained as a result of demodulation performed by the tuner 1301 passes through the adapter 1311 that has a descrambling function, and is transmitted to the TS decoder 1302. On the other hand, in the case where a broadcast signal of the terrestrial wave broadcasting system is received, an MPEG-2 transport stream obtained as a result of demodulation by the tuner 1301 is directly transmitted to the TS decoder 1302 without passing through the adapter 1311 with a descramble function.

The TS decoder 1302 is a device which has a function to segregate PES packets and MPEG-2 sections which comply with specified conditions from the MPEG-2 transport stream, based on a PID, a section filtering condition, and so on prescribed by the CPU 1306. In the case where a cable broadcast is received and a service is reproduced, the MPEG-2 transport stream outputted by the adapter 1311 is inputted to the TS decoder 1302. On the other hand, in the case where a terrestrial wave broadcast is received and a service is reproduced, the MPEG-2 transport stream outputted by the tuner 1301 is inputted to the TS decoder 1302.

The PES packets of the video and audio segregated by the TS decoder 1302 are outputted to the AV decoder 1303. In addition, the MPEG-2 section segregated by the TS decoder 1302 is transferred to the first memory unit 1308 through Direct Memory Access (DMA), and is used by a program executed by the CPU 1306.

The AV decoder 1303 is a device with a function to decode the encoded video ES and audio ES. The AV decoder fetches the ES from the PES packet which transmits the audio and video information transmitted from the TS decoder, and decodes the ES. An audio signal and a video signal obtained through the decoding performed by the AV decoder 1303 are outputted to the speaker 1304 and the display 1305 at the time of service reproduction, the speaker 1304 reproduces the audio outputted from the AV decoder 1303.

The display 1305 reproduces video outputted from the AV decoder 1303.

The CPU 1306 executes a program which operates in the broadcast receiving apparatus. The CPU 1306 executes a program contained in the ROM 1309. Otherwise, the CPU 1306 executes a program downloaded from a broadcast signal or a network and held in the first memory unit 1308. Otherwise, the CPU executes a program downloaded from a broadcast signal or a network and held in the second memory unit 1307. The tuner 1301, TS decoder 1302, AV decoder 1303, speaker 1304, display 1305, second memory unit 1307, first memory unit 1308, ROM 1309, input unit 1310, adapter 1311, AV encoder 1312 and multiplexer 1313 are controlled in accordance with the directions of the program to be executed. In addition, the CPU 1306 is capable of controlling the adapter 1311 by communicating not only with the devices which are present within the terminal apparatus 1300, but also with the devices which are present within the adapter 1311.

The second memory unit 1307 is a memory apparatus where memory is not deleted even if the power supply to the device is interrupted. Such second memory unit 1307 is configured of devices where information is not deleted even if the power supply to the terminal apparatus 1300 is cut off; for example, a nonvolatile memory such as a FLASH-ROM, a Hard Disk Drive (HDD), a rewritable media such as a CD-R and a DVD-R. The second memory unit 1307 saves information according to an instruction from the CPU 1306.

The first memory unit 1308 is a device which has a function for temporarily saving information in accordance with an instruction from the CPU 1306, a DMA-transferrable device, and so on, and is configured of a RAM or the like.

The RON 1309 is a non-rewritable memory device, and to be more specific, is configured of a ROM, a CD-ROM, a DVD, and the like.

The program which the CPU 1306 executes is stored in the ROM so 1309.

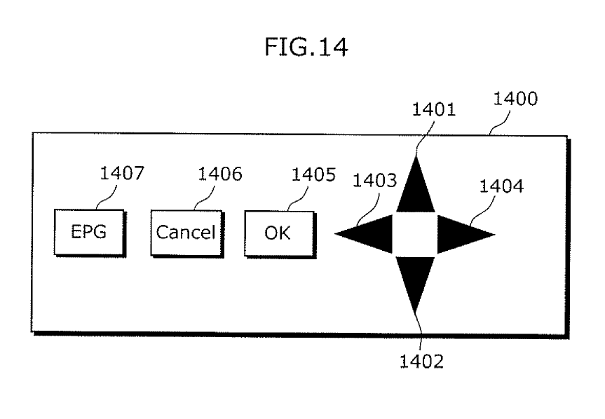

The input unit 1310 is, to be more specific, configured of a front panel or a remote control receiver, and accepts an input from the user. FIG. 14 is one example in the case where the input unit 1310 is configured by the front panel. A front panel 1400 has seven buttons: an up cursor button 1401, a down cursor button 1402, a left cursor button 1403, a right cursor button 1404, an OK button 1405, a cancel button 1406, and an EPG button 1407. When the user presses a button, an identifier of the pressed button is notified to the CPU 1306.

The adapter 1311 is a device for descrambling a scrambled MPEG-2 transport stream to be transmitted in the In-band frequency band, and includes one or more descramblers. The MPEG-2 transport stream outputted by the tuner 1301a is inputted into the adapter 1311, and the TS packet with the PID specified by the CPU 1306 is descrambled. The adapter 1311 outputs the descrambled MPEG-2 transport stream to the TS decoder 1302.

Furthermore, the adapter 1311 performs format conversion of data to be transmitted in an OOB frequency band at the time of receiving a broadcast signal of the cable broadcasting system. The information to be transmitted in the OOB frequency band may be modulated by the QPSK modulation scheme. Regarding out-bound transmission, the QPSK demodulator 1301b demodulates the signal transmitted from the broadcast station side system 101, and inputs the generated bit stream into the adapter 1311. The adapter 1311 extracts information specified by the CPU 1306 from among various types of information included in the bit stream, converts the information to a format which can be interpreted by a program which works in the CPU 1306, and provides this to the CPU 1306. On the other hand, regarding in-bound transmission, the CPU 1306 inputs, into the adapter 1311, information which is desired to be transmitted to the broadcast station side system 101. The adapter 1311 converts the information inputted from the CPU 1306 to a format which can be interpreted by the broadcast station side system 101, and inputs this to the QPSK modulator 1301c. The QPSK modulator 1301c QPSK-modulates the information inputted from the adapter 1311, and transmits this to the broadcast station side system.

A Cable CARD, formerly called a Point of Deployment (POD), used in the United States cable system, can be provided as a specific example of the adapter 1311.

The way the broadcast receiving apparatus described above operates reproduction of a service contained in a broadcast wave will be described below in detail.

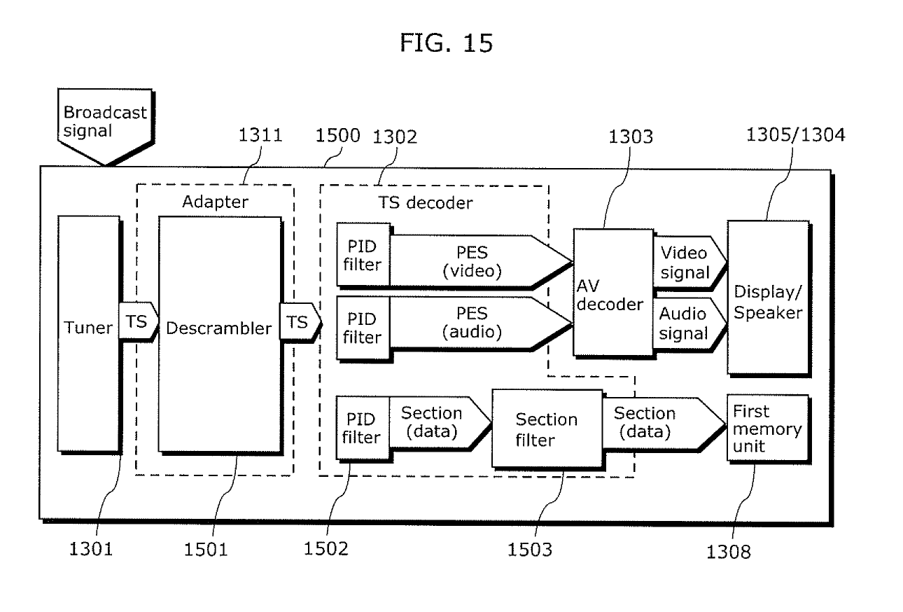

FIG. 15 shows a conceptual rendering which represents the physical connection sequence, processing details, and input and output data format of each device at the time when a broadcast signal of the cable broadcasting system is received. 1500 is a terminal apparatus, and includes: the tuner 1301; the adapter 1311; a descrambler 1501; the TS decoder 1302; a PID filter 1502; a section filter 1503; the AV decoder 1303; the speaker 1304; the display 1305; and the first memory unit 1308. Constituent elements in FIG. 15 which have the same reference numerals as the ones in FIG. 13 have the same functions and thus descriptions are omitted.

The tuner 1301 performs tuning of the broadcast wave in accordance with a tuning instruction provided by the CPU 1306, in the case where a broadcast signal of the cable broadcasting system is received. The tuner 1301 demodulates the broadcast wave and inputs the MPEG-2 transport stream into the adapter 1311.

The descrambler 1501, which is within the adapter 1311, descrambles the MPEG-2 transport stream based on conditional access release information for each viewer. The descrambled MPEG-2 transport stream is inputted into the TS decoder.

Two types of devices which process the MPEG-2 transport stream are present within the TS decoder 1302: the PID filter 1502 and the section filter 1503.

The PID filter 1502 extracts, from the inputted MPEG-2 transport stream, a TS packet which has a PID specified by the CPU 1306, and then extracts a PES packet and an MPEG-2 section present in that payload. For example, when the MPEG-2 transport stream in FIG. 6 is inputted in the case where the CPU 1306 has instructed PID filtering which extracts the TS packet with a PID=100, packets 601 and 603 are extracted, then connected, and thus a PES packet of a video 1 is reconfigured. Otherwise, when the MPEG-2 transport stream in FIG. 6 is inputted in the case where the CPU 1306 has instructed PID filtering which extracts the TS packet with a PID=200, packets 602 and 605 are extracted, then connected, and thus an MPEG-2 section of data 1 is reconfigured.

The section filter 1503 extracts, from among the inputted MPEG-2 sections, the MPEG-2 section which conforms to a section filtering condition specified by the CPU 1306 and DMA-transfers this MPEG-2 section to the first memory unit 1308. For example, it is assumed that the CPU 1306 specifies, for the section filter 1503, PID filtering which extracts the TS packet with a PID=200, and section filtering which extracts a section with a table_id of 64. As mentioned earlier, after the MPEG-2 section of the data 1 is reconfigured, the section filter 1503 extracts only the section with a table_id of 64 from among those MPEG-2 sections, and DMA-transfers this to the first memory unit 1308.

The MPEG-2 section inputted into the first memory unit 1308 is inputted into the CPU 1306 as appropriate.

A video PES packet and an audio PES packet extracted by the TS decoder 1302 are inputted into the AV decoder 1303.

The video PES and the audio PES inputted into the AV decoder 1303 are decoded and outputted as an audio signal and a video signal. Subsequently, the audio signal and the video signal are inputted into the display 1305 and the speaker 1304, thus the audio and the video are reproduced.

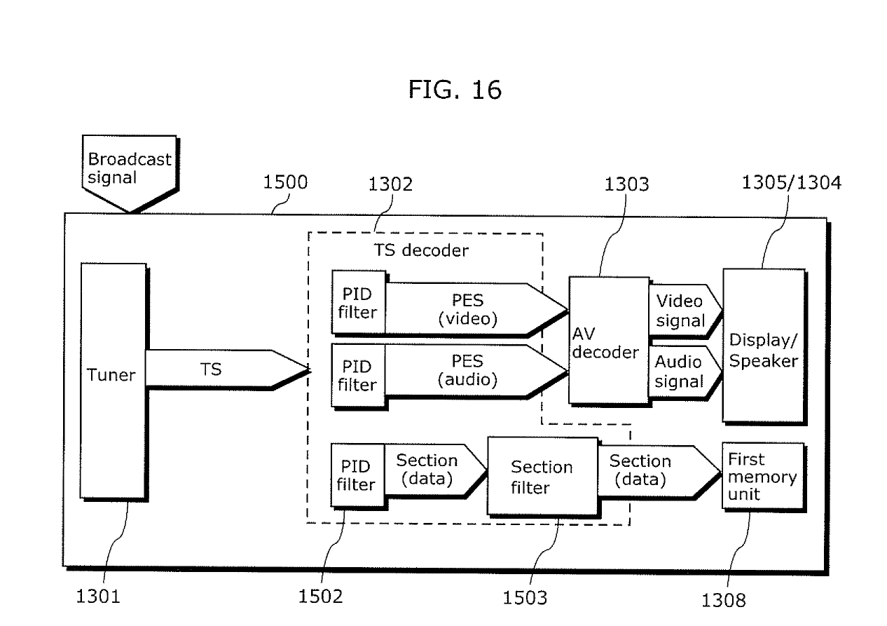

FIG. 16 shows a conceptual rendering which represents the physical connection sequence, processing details, and input and output data format of each device in the case where a broadcast signal of the terrestrial wave broadcasting system is received. Among the constituent elements in FIG. 16, the constituent elements having the functions equivalent to the ones in FIG. 15 are provided with the same reference numerals, and descriptions of them are omitted. Additionally, a physical connection order, processing details, and input and output data formats of the respective devices equivalent to the ones in FIG. 15 are also omitted, and only the differences will be described.

The tuner 1301 performs tuning of the broadcast wave in accordance with a tuning instruction specified by the CPU 1306 first, in the case where a broadcast signal of the terrestrial wave broadcasting system is received. The tuner 1301 demodulates the broadcast wave and inputs the MPEG-2 transport stream into the TS decoder 1302.

The connection sequence and processing details of the respective devices shown in FIG. 15 and FIG. 16 are switched depending on a type of a received broadcast signal. In other words, in the case of receiving a broadcast signal of the cable broadcasting system, the CPU 1306 performs settings of the hardware constituent elements shown in FIG. 13 so that a desired service is reproduced according to the connection sequence and processing details of the respective devices shown in FIG. 15. On the other hand, in the case of receiving a broadcast signal of the terrestrial wave broadcasting system, the CPU 1306 performs settings of the hardware constituent elements shown in FIG. 13 so that a desired service is reproduced according to the connection sequence and processing details of the respective devices shown in FIG. 16.

Thus far, an example of a hardware configuration regarding the present invention has been described. Hereafter, a main function of the present invention, which is reproduction control of a service by a Java program, is described.

Reproduction of the service in the present invention refers to execution and reproduction of the video, audio, a Java program contained in a broadcast wave, based on the synchronization information.

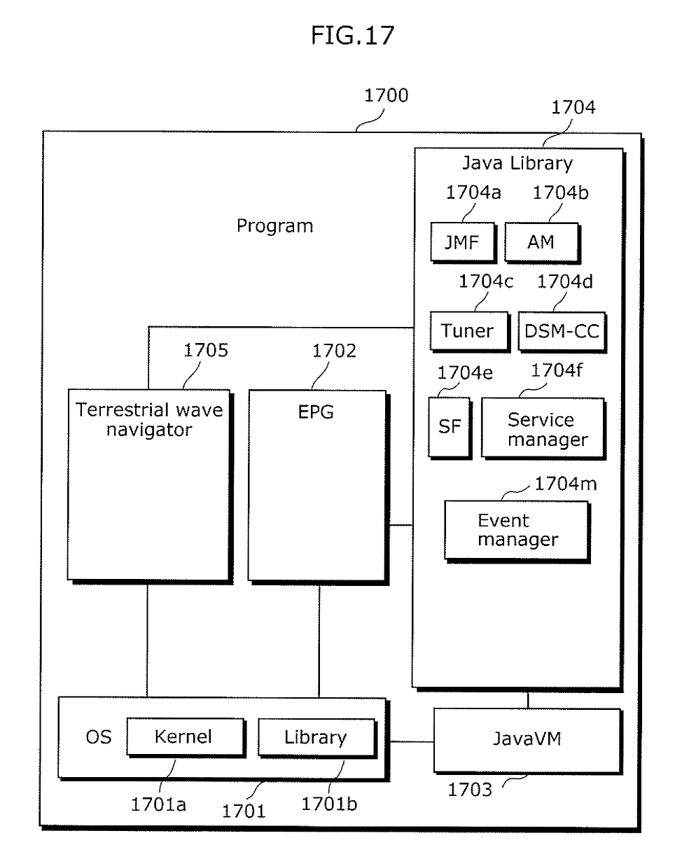

FIG. 17 is a configuration diagram of a program necessary for reproduction of the service in a broadcast receiving terminal where the cable television broadcasting system and the terrestrial wave broadcasting system coexist, and is software recorded in the ROM 1309.

A program 1700 is made up of an OS 1701, an EPG 1702, a Java VM 1703, a Java library 1704 and a terrestrial wave navigator 1705, which are sub-programs.

The OS 1701 is an Operating System; Linux, Windows, and the like are examples. The OS 1701 is configured by: a kernel 1701a for executing other sub-programs such as the EPG 1702 and the Java VM 1703; and a library 1701b used in order that the sub-programs controls the constituent elements of the terminal apparatus 1300. The kernel 1701a is publicly-known technology and therefore detailed description is omitted.

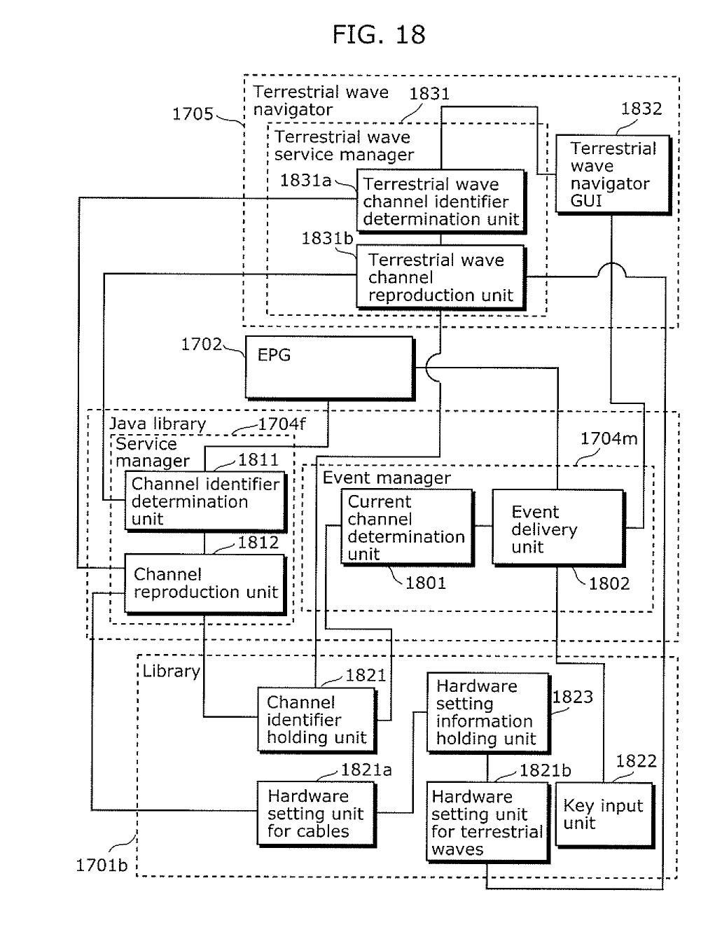

Among the constituent elements provided with the library 1701b, FIG. 18 shows only the constituent elements which are closely related to the present invention. The library 1701b includes a hardware setting unit for cables 1821a, a hardware setting unit for terrestrial waves 1821b, a key input unit 1822, a hardware setting information holding unit 1823, and a channel identifier holding unit 1824.

The hardware setting unit for cables 1821a performs settings of the connection between the hardware constituent elements shown in FIG. 13 so that the service is reproduced through a channel shown in FIG. 15, each time the channel reproduction unit 1812 makes a request that the service belonging to the cable broadcasting system is reproduced.

The hardware setting unit for terrestrial waves 1821b receives a channel identifier and a PID from the terrestrial wave channel reproduction unit 1831b. Each time the hardware setting unit 1821b is requested to perform settings of hardware connection and settings of values so that the service belonging to the terrestrial wave broadcasting system is reproduced, it performs settings of connection between the hardware constituent elements, settings of tuning information to the tuner and settings of the PID to the TS decoder which are shown in FIG. 13 so that the service is reproduced in the channel shown in FIG. 16. Further, it causes the hardware setting information holding unit 1823 to hold the setting details provided with the respective hardware constituent elements. The settings details include tuning information which is set in the tuner and the PID which is set in the TS decoder.

The key input unit 1822 receives a key input from the input unit 1310, and requests an event delivery unit 1801 of an event manager 1704m to deliver a key event corresponding to the inputted key. The event delivery by the event delivery unit 1801 will be described later on.

The hardware setting information holding unit 1823 holds a hardware setting unit for cables 1821a, a JMF 1704a, a tuner 1704c and a value which a hardware setting unit for terrestrial waves 1821b sets in the hardware. Upon receiving an inquiry from the current channel determination unit 1801, it returns the setting details provided with the respective hardware constituent elements such as the PID which is set in the TS decoder and the frequently information which is set in the tuner.

The channel identifier holding unit 1824 holds a channel identifier specified by the channel reproduction unit 1812 or the terrestrial wave channel reproduction unit 1831b.

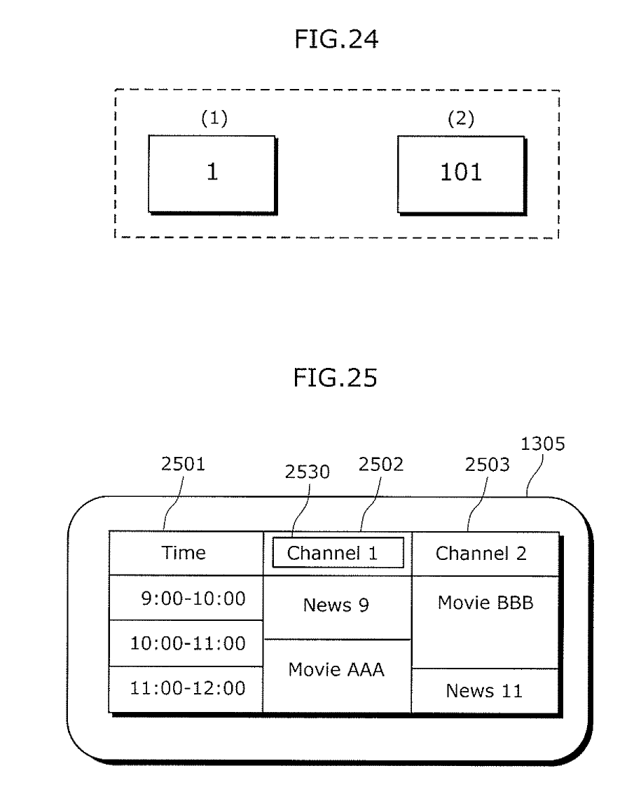

More specifically, a channel identifier “1” is specified from the channel reproduction unit 1812 with reference to FIG. 24, it holds “1” as shown in (1) in FIG. 24. Subsequently, in the case where a channel identifier “101” is specified from the terrestrial wave channel reproduction unit 1831b, it holds “101” as shown in (2) in FIG. 24. Further, upon receiving the inquiry from the current channel determination unit, the channel identifier holding unit 1824 returns the currently being held channel identifier.

The library 1701b is provided with various functions, which are not shown in the drawings, in addition to those functions. The library 1701b provides, for example, a tuning function for controlling the tuner. The library 1701b accepts, from another sub-program, tuning information that includes a frequency, and passes the information to the tuner 1301. The tuner 1301 performs demodulation processing based on the provided tuning information, and can pass the demodulated MPEG-2 transport stream to the TS decoder 1302. As a result, other sub-programs can control the tuner 1301 through the library 1701b.

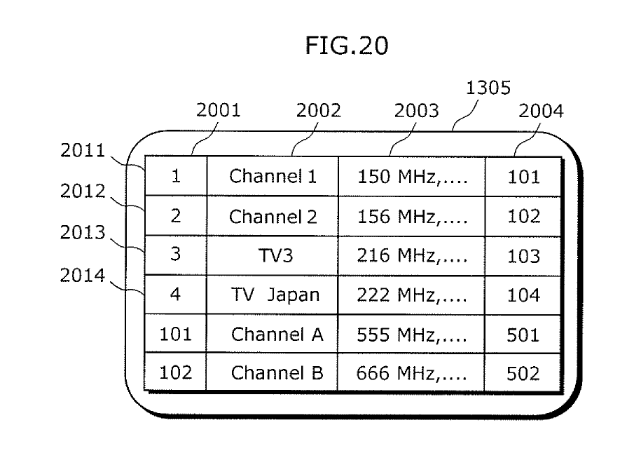

Also, the library 1701b provides channel information for uniquely identifying a channel. An example of the channel information is shown in FIG. 20. The channel information is transmitted using an OOB or an In-band frequency band, is converted into a table format by the adapter 1311, and is stored in a temporary memory unit accessible by the library. A column 2001 is a channel identifier, and is equivalent to, for example, a source_ID as defined by SCTE65 Service Information Delivered Out-Of-Band For Digital Cable Television. A column 2002 is a channel name, and is equivalent to a source_name, as defined by the SCTE 65 standard. A column 2003 is tuning information, and is information such as a frequency, a transfer rate, a modulation scheme, and the like that are provided to the tuner 1301. A column 2004 is a program number for specifying the PMT. For example, a line 2011 is a group of service information with a channel identifier of “1,” a channel name of “channel 1,” tuning information including a frequency of “150 MHz . . . , and a program number of “101.”

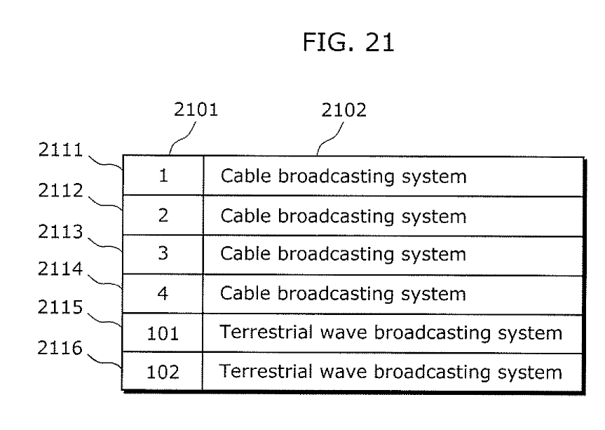

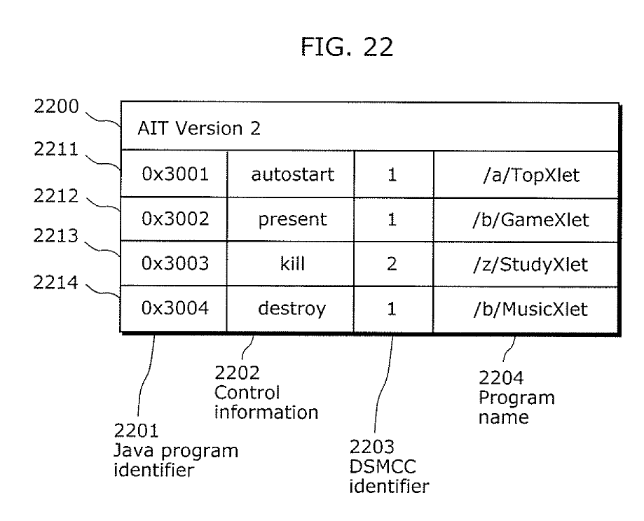

Also, the library 1701b provides information of broadcasting system to which the channel identifier belongs. FIG. 21 is a list of broadcasting system information which the library 1701b holds. A column 2101 is a channel identifier, and a column 2102 is a broadcasting system to which the channel identifier belongs. For example, a line 2115 shows that the channel identifier “1011” belongs to the “terrestrial wave broadcasting system”.

In addition to this, the library 1701b can set parameters for control of the hardware constituent elements shown in FIG. 13.

Individual functions are described later on.

The Java VM 1703 is a Java virtual machine which sequentially analyzes and executes programs written in the Java (TM) language.

Programs written in the Java language are compiled of intermediate codes called bytecodes which do not depend on hardware. The Java virtual machine is an interpreter which executes this bytecodes.

The Java VM 1703 executes the Java library 1704 written in the Java language. For details of the Java language and the Java VM, refer to publications such as “Java Language Specification” (ISBN0-201-63451-1) and “Java Virtual Machine Specification” (ISBN0-201-63451-X). In addition, it is possible to call or be called by other sub-programs which are not written in the Java language through a Java Native Interface (JNI). For details of the JNI, refer to the book “Java Native Interface” and so on.

The Java library 1704 is a library written in the Java language and is called by the Java program in order to control functions of the broadcast receiving apparatus. However, there are cases where a sub-program which is not written in the Java language, such as the library 1701b of the OS 1701, is used as necessary. The Java program can use a function provided by the Java library 1704 by calling a Java Application Programming Interface (Java API) held by the Java library 1704.

A tuner 1704c is a Java library for controlling the In-band receiving tuner 1301a in the broadcast receiving terminal. When the Java program such as the channel reproduction unit 1812, passes tuning information including a frequency to the tuner 1704c, the tuner 1704c sets the received tuning information in the tuner 1301 through the library 1701b. As the result, it can control operation of the tuner 1301a for receiving In-band signals of the broadcast receiving terminal. Further, the tuner 1704c causes the hardware setting information holding unit 1823 to hold the tuning information which is set in the tuner 1301, for example, the frequency information which is set in the tuner.

An SF 1704e is a Java library for controlling a function of the PID filter 1502 and the section filter 1503 of the broadcast receiving terminal. When the Java program passes filtering conditions such as a PID, table_id, and the like to the SF 1704e, the SF 1704e sets, based on the passed filtering conditions, filtering conditions in the PID filter 1502 and the section filter 1503 using a function of the library 1701b so as to control the PID filter 1502 and the section filter 1503, obtains MPEG-2 sections which fulfill desired filtering conditions, and passes the MPEG-2 sections to the Java program which has set the filtering conditions.

A DSM-CC 1704d is a Java library for accessing a file system of a DSMCC object carousel. The DSMCC object carousel is included in the MPEG-2 section to be obtained by the SF 1704e. The DSMCC is defined by the ISO/IEC 13818-6 standard, and is a mechanism for transmitting an arbitrary file, using the MPEG-2 section. By using this system, it is possible to transmit a file from a broadcast station to a terminal. The DCM-CC 1704d obtains the MPEG-2 section using the SF 1704e, based on a file identifier specified by a Java program or the like, takes out a file based on the ISO/IEC 13818-6 standard, and outputs the file to the first memory unit 1308. A detailed method for implementing the DSM-CC is of no relation to the present invention, and thus the description is omitted An AM 1704b is an application manager which provides a function for managing the execution and termination of the Java programs downloaded from the cable broadcast waves. The Java programs downloaded from the cable broadcast waves include: a Java program which is included in a service and is executed at the time when the service is selected; and a Java program which is not included in a service and is executed irrespective of a selection of the service, in other words, the latter Java program is not terminated even in services are switched. The former Java program is downloaded according to the information described in AIT and executed. The latter Java program is downloaded according to the information described in XAIT and executed. The AIT and the XAIT will be described later on.

Firstly described is a function of the AM 1704b when it downloads, executes and terminates a Java program included in a service according to the information described in the AIT.

The AM 1704b extracts a Java program multiplexed onto a specified channel of an MPEG-2 transport stream of the cable broadcast outputted from the adapter 1311. It executes or terminates the extracted Java program according to the synchronization information which has been separately multiplexed. A Java class file of the Java program is multiplexed onto the MPEG-2 transport stream in the aforementioned DSMCC format. In addition, the synchronization information of the Java program is multiplexed onto the MPEG-2 transport stream in a format called AIT. AIT is an acronym of Application Information Table, as defined in Chapter 10 of the DVB-MHP standard (ETSITS 101812 DVB-MHP specification V1.0.2, and is an MPEG-2 section with a table_id of “0x74.” In the present embodiment, the AIT defined by the DVB-MHP standard is modified for use.

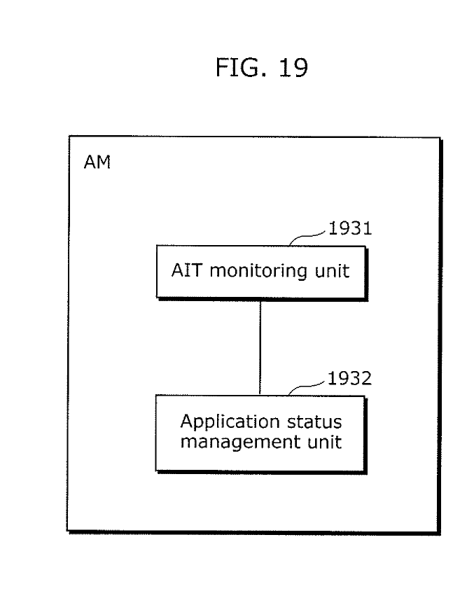

Among the internal elements of the AM 1704b, only the elements which are closely related to the functions at the time of downloading, executing and terminating the Java program included in the service will be shown in FIG. 19. The AM 1704b is configured by an AIT monitoring unit 1931 and an application status management unit 1932.

The AIT monitoring unit 1931 has an MPEG-2 transport stream of the cable broadcast and a channel identifier as inputs, and monitors the update status of the AIT. First, the JMF 1704b searches the library 1701b for channel information using a specified channel identifier as a key, and obtains the program number. Next, using the SF 1704e and the like, a PAT is obtained from the MPEG-2 transport stream. Further, the PID of the PMT corresponding to the obtained program number is obtained from the information of the PMT. It is in a format as shown in FIG. 11, and the PIDs of elementary streams which have “data” as a stream type and “AIT” as supplemental information are written therein using the SF 1704e again. Furthermore, when providing the SF 1701e with the PID and table_ID “0x74” of the AIT now obtained as the filtering conditions, the details of the AIT can be obtained.

FIG. 22 is a chart which schematically shows an example of the AIT information. The AIT version 2200 represents the version of that AIT. The higher the version of the AIT, the newer the AIT is. An AIT of the same AIT version is repeatedly received, but the AM 1704b does not analyze an AIT with the same AIT version as an AIT which has already been analyzed, but analyzes only an AIT which is newer than the already-analyzed AIT and performs the corresponding processing.

A column 2201 is an identifier of the Java program. A column 2202 is control information of the Java program. In the control information, there is “autostart,” “present,” “kill,” and the like; “autostart” means that the terminal apparatus 1300 executes the Java program automatically in an instant, “present” means not performing automatic execution, and “kill” means stopping the Java program. A column 2203 is a DSMCC identifier for extracting the PID which includes the Java program in the DSMCC format. A column 2204 is a program name of the Java program. Lines 2211, 2212, 2213, and 2214 are a group of the information of the Java program. The Java program defined by the line 2211 is a group including a Java program identifier “0x3221”, control information “autostart,” aDSMCC identifier “1”, and a program name “a/TopXlet”. Similarly, the Java program defined by the line 2212 is a group including a Java program identifier “0x3222,” control information “present,” a DSMCC identifier “1,” and a program name “a/GameXlet”.

Here, the three Java programs defined by the line 2211, line 2212, and line 2214 have the same DSMCC identifier. This indicates that three Java programs are included in one file system encoded in the DSMCC format. Here, four types of information are prescribed for the Java program, but in reality, more types of information are defined. Details can be found in the DVB-MHP standard.

The application status management unit 1932 analyzes the updated AIT content and manages the execution status of the Java program, based on the details of the AIT.

First, the operation of managing the status of a Java program will be described below. The application status management unit 1932 finds out a Java program whose control information is “autostart” from among the AITs, and extracts the corresponding DSMCC identifier and Java program name. Referring to FIG. 22, the AM 1704b extracts the Java program from the line 2211 and obtains the DSMCC identifier of “1” and the Java program name of “a/TopXlet.” Next, the AM 1704b uses the DSMCC identifier obtained from the AITs so as to obtain, from the PMT, the PID of the TS packet storing the Java program in the DSMCC format. Specifically, the PID of the elementary stream with a conforming DSMCC identifier in the supplementary information and with a stream type of “data” is obtained from among the PMTS. Here, assuming that the DSMCC identifier is “1” and the PMT is as shown in FIG. 11, the elementary streams of the line 1114 conform to them, and the PID “5014” is fetched.

The AM 1704b specifies, to the SF 1704e, the section filtering conditions, and the PID of the TS packet which transmits the MPEG-2 section in which data is embedded in the DSMCC format. Here, the PID “5014” is provided. As a result, the AM 1704b can collect the necessary DSMCC MPEG-2 sections. The AM 1704b reconstructs the file system from the collected MPEG-2 sections according to the DSMCC format, and saves the file system into the first memory unit 1308. Fetching data such as the file system from the TS packet in the MPEG-2 transport stream and saving the data into a storage means such as the first memory unit 1308 and the second memory unit 1307 is hereafter called downloading.

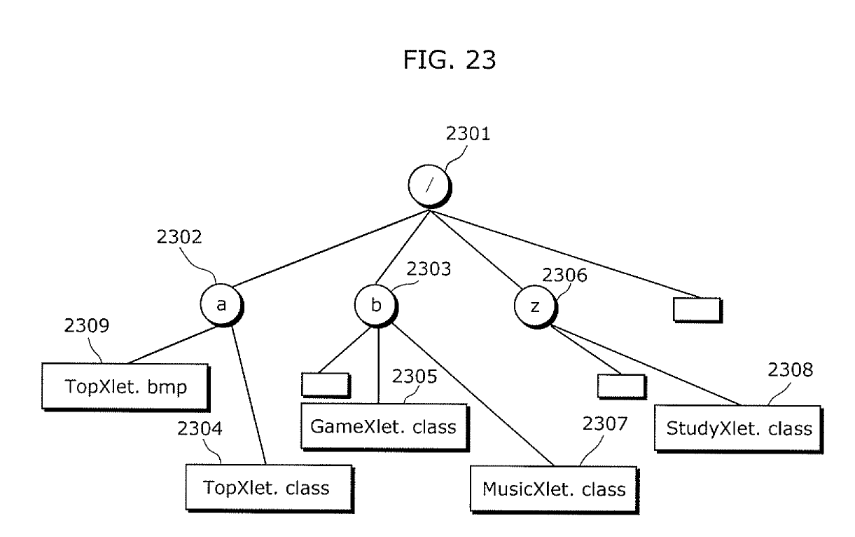

FIG. 23 is an example of a downloaded file system. In the diagram, a circle represents a directory and a square represents a file. 2301 is a root directory, 2302 is a directory “a”, 2303 is a directory “b”, 2304 is a file “TopXlet.class”, 2305 is a file “GameXlet.class”, 2306 is a directory “z”, 2307 is a file “MusicXlet.class”, and 2308 is a file “StudyXlet.class”.

Next, from among the file systems downloaded in the first memory unit 1308, the AM 1704b passes the Java program to be executed to the Java VM 1703. Here, assuming that the name of the Java program to be executed is “a/TopXlet,” the file “a/TopXlet.class,” with added “.class” at the end of the Java program name, is the file to be executed. “/” is a delimiter between directories and between file names, and the file 2304 is the Java program which should be executed with reference to FIG. 23. Next, the AM 1704b passes the file 2304 to the Java VM 1703, and the file is executed, as a Java program, on the Java VM.

Every time the AM 1704b receives an AIT with a new AIT version, it analyzes the AIT and changes the execution status of the Java program.

The functions described above is the functions which the AM 1704b performs according to the information described in AIT when downloading, executing and terminating the Java program contained in the service.

The functions which will be described next are the functions which the AM 1704b performs according to the information described in XAIT when downloading, executing and terminating the Java program which is not included in a service, and executed irrespective of a selection of the service, in other words, is not terminated even if services are switched.

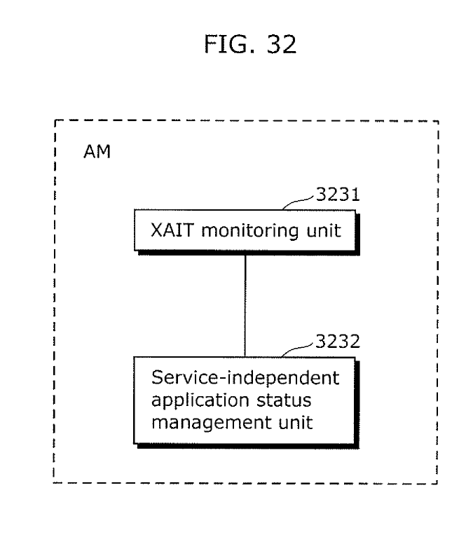

Among the internal constituent elements of the AM 1704b, FIG. 32 shows only the constituent elements which are closely related to the functions in downloading, executing and terminating the Java program which is not included in a service, and is executed irrespective of a selection of the service, in other words, is not terminated even if services are switched. The AM 1704b is configured by an XAIT monitoring unit 3231 and a service-independent application status management unit 3232.

The XAIT monitoring unit 3231 can obtain information from the broadcasting station side system 101 by communication with the broadcasting station side system 101 through the library 1701b. This two-way communication can be realized by the QPSK demodulation unit 502 via the library 1701b of the OS 1701 and the adapter 1311.

The XAIT monitoring unit 3231 receives, from the broadcasting station side system 101 using this communication, information of the Java (TM) program which should be executed or which the terminal apparatus 1300 saves in the second memory unit 1307. This information is referred to as XAIT information. The XAIT information is transmitted between the broadcasting station side system 101 and the adapter 1311 in an arbitrary format. The present invention can be implemented irrespective of which transmission format is employed, as long as information required for XAIT information is contained.

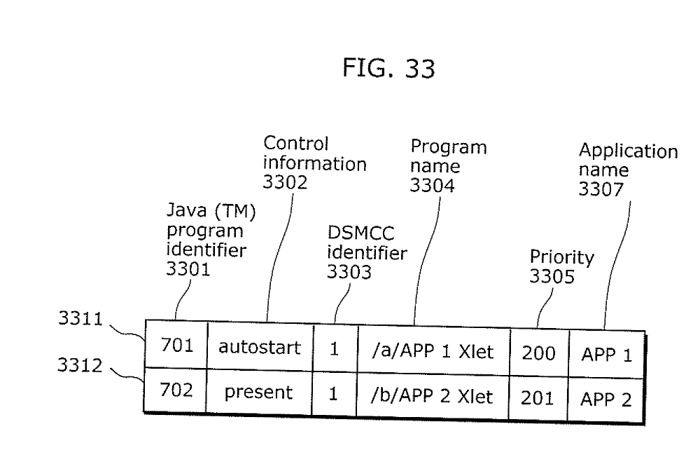

FIG. 33 is a diagram which schematically shows an example of the XAIT information obtained from the broadcasting station side system 101. A column 3301 is an identifier of the Java (TM) program. A column 3302 is control information of the Java (TM) program. The control information includes “autostart,” “present,” and the like; “autostart” means that the terminal apparatus 1300 executes this program automatically at the time when power is turned on and “present” means not performing automatic execution.

A column 3303 is a DSMCC identifier for extracting the packet ID which includes the Java (TM) program in the DSMCC format. A column 3304 is a program name of the Java (TM) program. The column 3305 describes the priority of the Java (TM) program. Priority is intended for determining a Java (TM) program to be executed in the case where there is a restriction on the Java (TM) programs which are executable. The column 2007 describes the application name of the Java (TM) program. The application name is intended for allowing a user to identify a Java (TM) program. The lines 2011 and 2012 are a group of information of the Java (TM) program. The Java (TM) program defined by the line 2011 is a group including an identifier “701”, control information “autostart,” aDSMCC identifier “1”, a program name “a/APP1Xlet”, a priority “200” and an application name “APPI”. Here, only six types of information are prescribed for the Java (TM) program, but the present invention is implementable even if more types of information are defined.

The application name of the column 3307 is for example, a name used for allowing a user to identify each Java (TM) program described in XAIT information. However, it should be noted that the present invention is implementable without any application name, on condition that sufficient information for allowing a user to identify a Java (TM) program is presented to the user.

The application status management unit 3232 analyzes the updated details of the XAIT and manages the execution status of the Java program, based on the details of the XAIT.

The service-independent application status management unit 3232 extracts, downloads and executes the Java (TM) program described in the obtained XAIT information, from the MPEG-2 transport stream of the cable broadcast. Upon obtaining the XAIT information, the service-independent application status management unit 3232 saves a file system from the MPEG-2 transport stream into the first memory unit 1308, according to the same procedures as the procedures at the time when the application status management unit 1932 downloaded the Java (TM) program from the AIT information. Subsequently, the file system saved in the first memory unit 1308 is copied in the second memory unit 1307. Note that it is possible to directly download the file system to the second memory unit 1307 without passing it through the first memory unit 1308. Next, the service-independent application status management unit 3232 associates the storage position of the downloaded file system with the XAIT information and saves the file system in the second memory unit 1307.

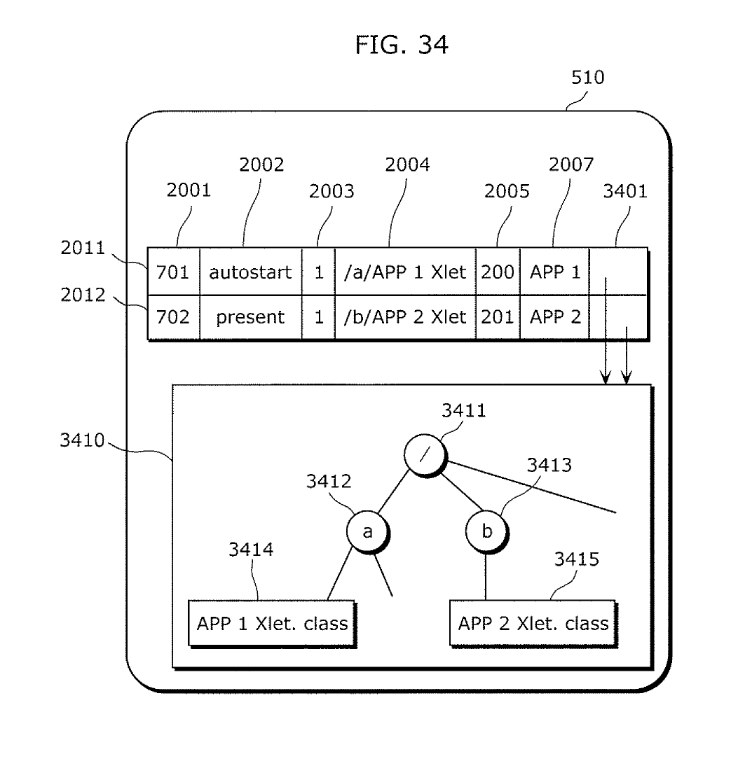

FIG. 34 shows an example where the downloaded file system is saved associated with the XAIT information in the second memory unit 510. Since the elements in FIG. 34 provided with the same reference numerals as the ones in FIG. 34, the descriptions are omitted. A column 3401 saves the storage position of the downloaded file system corresponding to each Java (TM) program. In the figure, such storage positions are shown by arrows. 3410 is the downloaded file system storing a top directory 3411, a directory “a” 3412, a directory “b” 3413, a file “APP1Xlet. class” 3414, a file “APP2Xlet. class” 3415.

Here, the XAIT information is saved after the Java (TM) program is stored, but it can be saved before the Java (TM) program is stored. The XAIT information is saved in the second memory unit 1307, but note that it can be saved in the first memory unit 1308. In the case of saving it in the first memory unit 1308, all the stored XAIT information is deleted at the time of power OFF.

Next, referring to the XAIT information saved in the first memory unit 1308 or the second memory unit 1307, the service-independent application status management unit 3232 passes the Java (TM) program of the application specified as “autostart” from among the downloaded applications to the Java VM 1703. Referring to FIG. 34, the Java (TM) program “a/APP1Xlet” of the application “APP1” defined by the line 2011 is passed to the VM 1703. Here, when the name of the Java program to be executed is “a/APP1Xlet”, the file “a/APP1Xlet. class” to which “.class” is added at the end of the Java program name, is the file to be executed. The Java VM 1703 executes the Java (TM) program of the passed application.

The functions described above are the functions which the AM 1704b performs according to the information described in the XAIT when downloading, executing and terminating the Java program contained in the service.

The JMF 1704a handles reproduction control of the video and audio included in the service of the cable broadcast. More specifically, the JMF 1704a inputs the video ES and audio ES multiplexed on the specified channel of the MPEG-2 transport stream, into the AV decoder for reproduction.

First, when a channel identifier is inputted, the JMF 1704a searches the library 1701b for channel information using a specified channel identifier as a key, and obtains the program number. Next, using the SF 1704e and the like, a PAT is obtained from the MPEG-2 transport stream. Further, the PID of the PMT corresponding to the obtained program number is obtained from the information of the PAT. Using the SF 1704e again, the details of the PMT are obtained.

The obtained PMT is in a format as shown in FIG. 11, and the PIDs of the elementary streams are written as “video” and “audio” which are the stream types of the elementary streams.

Subsequently, the JMF 1704a sets these PIDs in the PID filter 1502 of the TS decoder 1311 via the library 1701b. As a result, as shown in FIG. 15, a video ES and an audio ES multiplexed with these PIDs are reproduced through the AV decoder 1303, the speaker 1304 and the display 1305. Further, the JMF 1704a causes a hardware setting information holding unit 1823 to hold a PID, such as a “video” PID, which has been set in the TS decoder.

The service manager 1704f manages reproduction of a service in the MPEG-2 transport stream of the cable broadcast. The embodiment which will be described below is the embodiment of managing reproduction of the service within the MPEG-2 transport stream.

FIG. 18 shows an internal configuration of the service manager 1704f. The service manager 1704f includes a channel identifier determination unit 1811 and a channel reproduction unit 1812.

The channel identifier determination unit 1811 of the service manager 1704f has the channel identifier of the service to be reproduced as an input. The channel identifier determination unit 1811 of the service manager 1704f receives a service reproduction request from an EPG by receiving the channel identifier. Referring to a list of the broadcasting system information held by the library 1701b and shown in FIG. 21, the channel identifier determination unit 1811 determines the one of the cable television broadcasting system and the terrestrial wave broadcasting system to which the specified channel identifier belongs.

Subsequently, in the case where the result of judging the specified channel identifier shows the cable broadcasting system, the channel identifier determination unit 1811 delivers the channel identifier to the channel reproduction unit 1812 and requests it to reproduce the serve. On the other hand, the result of judging the specified channel identifier shows the terrestrial wave system, the channel identifier determination unit 1811 passes the channel identifier for reproducing the service to the terrestrial wave channel reproduction unit 1831b of the terrestrial wave service manager 1831, and makes a reproduction request of the service belonging to the terrestrial wave broadcasting system.

Upon receiving the reproduction request of the service with the specified channel identifier from the channel identifier determination unit 1811 or the terrestrial wave channel identifier 1831a, the channel reproduction unit 1812 request the hardware setting unit for cables 1821a of the library 1701b to set hardware connection so as to reproduce the service belonging to the cable broadcasting system using the channel shown in FIG. 15.

Subsequently, referring to the guide shown in FIG. 20 held by the library 1701b, the channel reproduction unit 1812 obtains tuning information corresponding to the specified channel identifier and specifies the obtained tuning information to the tuner 1704c.

Subsequently, the channel reproduction unit 1812 provides the specified channel identifier to the JMF 1704a and requests it to reproduce the video and audio. Then, through the above-described operation, the JMF 1704a starts reproduction of the audio and video multiplexed within the MPEG-2 transport stream of the cable broadcast. Furthermore, the AM 1704b is also provided with the channel identifier of the video and audio to be reproduced in the MPEG-2 transport stream of the cable broadcast. Then, according to the AIT multiplexed onto the MPEG-2 transport stream, the AM 1704b starts execution and termination of the Java program multiplexed onto the MPEG-2 transport stream of the cable broadcast.

Subsequently, the channel reproduction unit 1812 requests the channel identifier holding unit 1824 to hold the specified channel identifier. Then, it hides, from the display 1305, all the programs including the terrestrial wave navigator GUI belonging to the terrestrial wave broadcasting system. Then, the channel reproduction unit 1812 displays Java programs including the EPG 1702 belonging to the cable broadcasting system on the display 1305, and provides a focus on one of the Java programs.

The event manager 1705m receives the key event corresponding to the key input from the key input unit of the library, and delivers the key event, based on the broadcasting system to which the currently being reproduced service belongs.

More specifically, in the case where a service belonging to the cable broadcasting system is being reproduced, it delivers the key event to the EPG 1702. In the case where a service belonging to the terrestrial broadcasting system is being reproduced, it delivers the key event to the terrestrial wave navigator 1705.

FIG. 18 shows an internal configuration of the event manager 1705m. The event manager 1705m is configured by a current channel determination unit 1801 and an event delivery unit 1802.

Upon receiving an inquiry from the event delivery unit 1802, the current channel determination unit 1801 determines the one of the cable broadcasting system and the terrestrial wave broadcasting system to which the currently being reproduced service belongs, and notifies the result to the event delivery unit 1802.

Here, the determination of a broadcasting system by the current channel determination unit 1801 is realized according to the following method, in this embodiment.

Upon receiving an inquiry from the event delivery unit 1802, the current channel determination unit 1801 makes an inquiry to the channel identifier holding unit 1824 in respect to the channel identifier of the service which has been specified and is currently being reproduced. The current channel determination unit 1801 determines the one of the cable broadcasting system and the terrestrial wave broadcasting system to which the currently being reproduced service belongs by searching the list of broadcasting system information shown in FIG. 21 using the obtained channel identifier as the key. In this method, the channel identifier, of the service which is currently being reproduced, which is held by the channel identifier holding unit 1824 is the basis of the determination of the broadcasting system.

The event delivery unit 1802 delivers the key event based on the determination of the current channel determination unit 1801. More specifically, upon receiving the key event from the input unit 1822 of the library, the event delivery unit 1802 makes an inquiry to the current channel determination unit 1801 in respect to the broadcasting system to which the currently being reproduced service belong. In the case where the service which belongs to the cable broadcasting system is being reproduced, it converts the key event to the key event defined by Java AWT, and delivers it to the Java program which belongs to the cable broadcasting system, is being executed in an environment for cable broadcasting reproduction, and provided with the focus.

On the other hand, in the case where a service belonging to the terrestrial wave broadcasting system is being reproduced, it converts the key event into the key event which can be interpreted by the programs including the terrestrial wave navigator GUI 1832 belonging to the terrestrial wave broadcasting system, and delivers it to the program which belongs to the terrestrial wave broadcasting system, in other words, which is being executed in an environment for the terrestrial wave broadcasting reproduction and is provided with the focus.

Here, it should be noted that the present invention is implementable even if the conversion format of the key event by the event delivery unit 1802 is another format, as long as the event format can be interpreted by the delivery destination.

The EPG 1702 (EPG is an abbreviation of Electric Program Guide) is a function which causes a user to select a TV show program to be reproduced. The EPG 1702 is a Java program which belongs to the cable broadcasting system and is being downloaded and executed according to the XAIT information. It is executed independent from a selection of a service, in other words, is not terminated even if services are switched. Reproduction of a TV show program selected by the GUI of the EPG 1702 is performed by means that a channel identifier is passed to the channel identifier determination unit 1811 of the service manager 1704f and the reproduction of the service is requested.

The EPG 1702 displays a list of broadcast TV show programs, and causes the user to select a desired TV show program. FIG. 25 is an example of a screen display for causing a user to select a TV show program to be reproduced. A time 2501 and channels 2502 and 2503 are displayed in a grid-form, and it is possible to check the TV show program of each recordable channel at each time. The EPG can receive the key input from the user by the event delivery unit. Thus, it is possible for the user to move a focus 2530 within the screen by using top, bottom, right, and left cursor buttons 1401 to 1404 which are included in the input unit 1310 of the terminal apparatus 1300. Furthermore, when the OK button 1405 is pressed, the TV show program in focus is selected to be reproduced.

The EPG 1702 obtains the channel identifier of the TV show program from the library, and when the TV show program to be reproduced is selected by the user, passes the channel identifier of the TV show program to the channel identifier determination unit 1811 and direct it to reproduce the service.

FIG. 18 shows an internal configuration of the terrestrial wave navigator 1705. The terrestrial wave navigator 1705 is configured by a terrestrial wave service manager 1831 and a terrestrial wave navigator GUI 1832. Further, the terrestrial wave service manager 1831 includes a terrestrial wave channel identifier determination unit 1831a and a terrestrial wave channel reproduction unit 1831b.

The terrestrial wave navigator GUI 1832 is an electric program guide, and has a function for allowing a user to select a TV show program to be reproduced. The terrestrial wave navigator GUI 1832 is a program belonging to the terrestrial wave broadcasting system. The TV show program is reproduced by passing the channel identifier to the channel identifier determination unit 1831a of the terrestrial wave service manager 1831 and requesting it to reproduce the service.

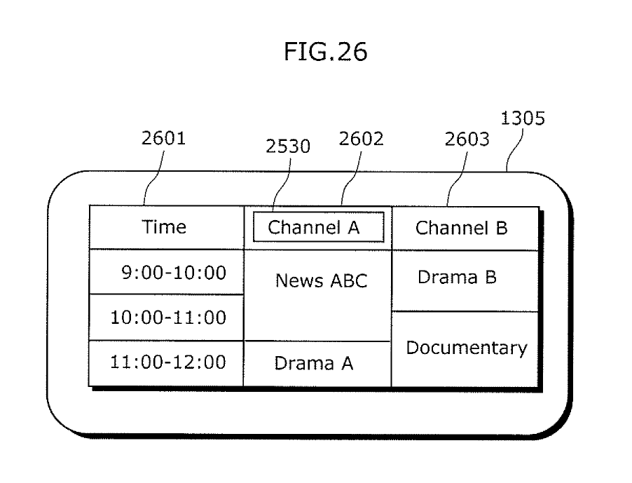

The terrestrial wave navigator GUI 1832 displays a list of broadcast TV show programs, and allows the user to select a desired TV show program. FIG. 26 is an example of a screen display for allowing the user to select the TV show program to be reproduced. A time 2601 and channels 2602 and 2603 are displayed in a grid-form, and the user can check the TV show programs of each recordable channel at each time.

The terrestrial wave navigator GUI 1832 can receive the key input from the user by the event delivery unit. Thus, the user can move a focus 2830 within the display screen by using top, bottom, right, and left cursor buttons 1401 to 1404, which are included in the input unit 1310 of the terminal apparatus 1300.

Furthermore, when the OK button 1405 is pressed, the TV show program in focus is selected to be reproduced. The terrestrial wave navigator GUI 1832 obtains the channel identifier of the TV show program from the library and knows it. When the TV show program to be reproduced is selected by the user, it passes the channel identifier of the TV show program to the terrestrial wave channel identifier determination unit 1831a and directs it to reproduce the service.

Referring to the list of the broadcasting system information shown in the above-mentioned FIG. 21, the terrestrial wave channel identifier determination unit 1831 of the terrestrial wave service manager 1831 determines the one of the cable television broadcasting system and the terrestrial wave broadcasting system to which the specified channel identifier belongs, at the time of receiving the service reproduction request from the terrestrial wave navigator GUI 1832.

Subsequently, in the case where the result of the determination by the terrestrial wave channel identifier determination unit 1831a shows the terrestrial wave broadcasting system, the terrestrial channel identifier determination unit 1831a delivers the channel identifier to the terrestrial channel reproduction unit 1831b and requests it to reproduce the service. On the other hand, in the case where the result of the determination by the terrestrial wave channel identifier determination unit 1831a, the terrestrial wave channel identifier determination unit 1831a passes the channel identifier for reproducing the service to the channel reproduction unit 1812 of the service manager 1704f and requests it to reproduce the service belonging to the cable broadcasting system.

Upon receiving a reproduction request of the service with the specified channel identifier from the terrestrial wave channel identifier determination unit 1831a or the channel identifier determination unit 1811, the terrestrial wave channel reproduction unit 1831b obtains the tuning information corresponding to the specified channel identifier with reference to the guide shown in FIG. 20 held by the library 1701b. In addition, it searches the library 1701b for channel information using the specified channel identifier as a key, and obtains the program number. Next, using the SF 1704e and the like, a PAT is obtained from the MPEG-2 transport stream. Further, the PID of the PMT corresponding to the obtained program number is obtained from the information of the PMT. Using the SF 1704e again, it obtains the details of the PMT. The obtained PMT has a format of FIG. 11, and the PIDs of elementary streams are written in it as “video” and “audio” which are the stream types of the elementary streams.

Subsequently, the terrestrial wave channel reproduction unit 1831b specifies the obtained tuning information and the PIDs to the hardware setting unit for terrestrial waves of the library 1701b. The terrestrial wave channel reproduction unit 1831b requests the hardware setting unit for terrestrial waves to perform settings of hardware connection so that the service belonging to the terrestrial wave broadcasting system is reproduced through the channel shown in FIG. 16 and settings of the values to the tuner and the TS decoder.

Subsequently, the terrestrial channel reproduction unit 1831b requests the channel identifier holding unit 1824 to hold the specified channel identifier. Then, it hides all the Java programs including the EPG 1702 belonging to the cable broadcasting system from the display 1305. On the other hand, the terrestrial wave channel reproduction unit 1831b displays the programs including the terrestrial wave navigator GUI belonging to the terrestrial wave broadcasting system on the display 1305, and provides a focus on one of the programs.

Characteristic operations in this embodiment by the above-described configuration will be described below with reference to a flow chart.

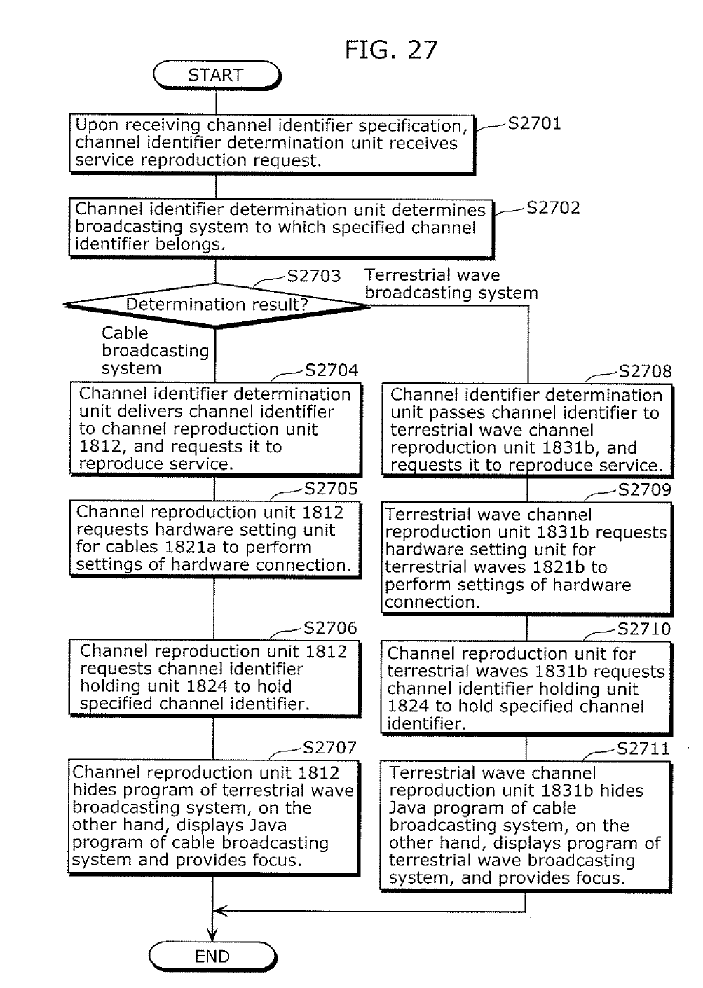

FIG. 27 is a flow chart showing an example of the processing in the case where a channel identifier is passed by the EPG 1702 to the channel identifier determination unit 1811. Upon receiving the channel identifier from the EPG 1702 and receiving a reproduction request of the service (S2701), the channel identifier determination unit 1811 determines the one of the cable television broadcasting system and the terrestrial wave broadcasting system to which the channel identifier belongs (S2702).

In the case where the determination result shows the cable broadcasting system (S2703), the channel identifier determination unit 1811 delivers the channel identifier to the channel reproduction unit 1812 and requests it to reproduce the service (S2704). When the channel identifier is specified and reproduction of the service is requested by the channel identifier determination unit 1811, the channel reproduction unit 1812 specifies a channel identifier to the hardware setting unit for cables 1821a of the library 1701b and makes a setting request of hardware connection so that the service belonging to the cable broadcasting system is reproduced through the channel shown in FIG. 15 (S2705).

Subsequently, the channel reproduction unit 1812 requests the channel identifier holding unit 1824 to hold the specified channel identifier (S2706).

The channel reproduction unit 1812 hides the program of the terrestrial wave broadcasting system, displays the Java program of the cable broadcasting system and provides a focus (S2707).

On the other hand, in the case where the determination result in S1703 of the channel identifier determination unit 1811 is the terrestrial wave system, the channel identifier determination unit 1811 passes the channel identifier for reproducing the service to the terrestrial wave channel reproduction unit 1831b, and requests it to reproduce the service belonging to the terrestrial wave broadcasting system (S2708).

Upon receiving a reproduction request of the service with the specified channel identifier from the channel identifier determination unit 1811, the terrestrial wave channel reproduction unit 1831b specifies the channel identifier to the hardware setting unit for terrestrial waves 1821b of the library 1701b, and requests settings of the hardware connection so that the service belonging to the terrestrial wave cable broadcasting system is reproduced through the channel shown in FIG. 16 (S2709).

Subsequently, the terrestrial wave channel reproduction unit 1831b requests the channel identifier holding unit 1824 to hold the specified channel identifier (S2710).

The terrestrial wave channel reproduction unit 1831b hides the program of the cable broadcasting system, displays the program of the terrestrial wave broadcasting system, and provides a focus (S2711).

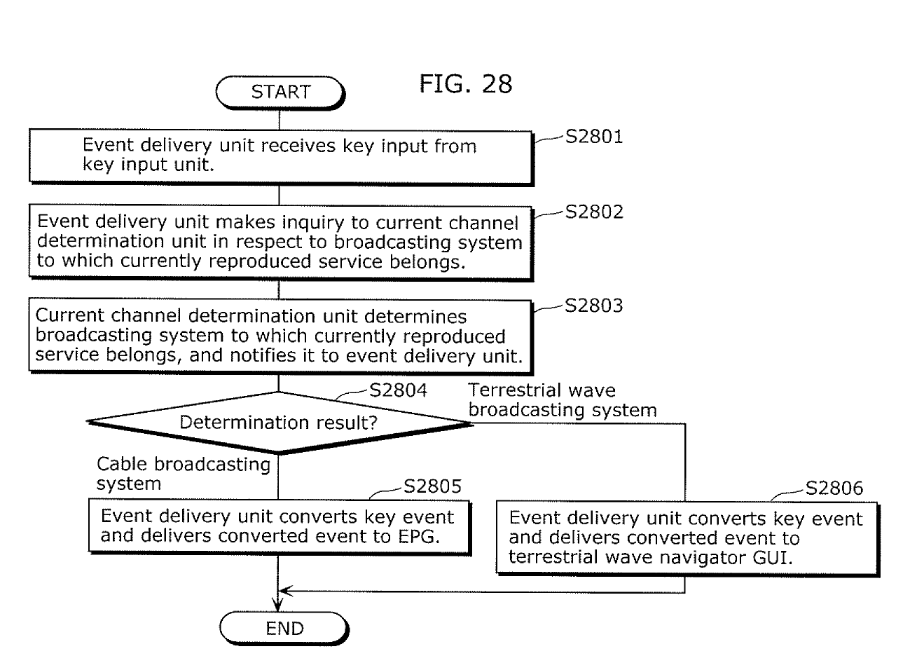

FIG. 28 is a flow chart showing an example of the processing at the time when the event delivery unit 1802 receives a key input from the key input unit 1822. Here, the EPG has a focus when the cable broadcast is reproduced, and the terrestrial wave navigator GUI has a focus when the terrestrial wave broadcast is reproduced.

Upon receiving the key input from the key input unit 1822 (S2801), the event delivery unit 1802 makes an inquiry to the current channel determination unit 1801 in respect to the broadcasting system to which the currently being reproduced service belongs (S2802).

Upon receiving the inquiry, the current channel determination unit 1801 determines the one of the cable broadcasting system and the terrestrial wave broadcasting system to which the currently being reproduced service belongs, and notifies the determination result to the event delivery unit 1802 (S2803).

In the case where the determination result of the current channel determination unit 1801 shows the cable broadcasting system (S2804), the event delivery unit 1802 converts the key event into an event which can be defined in Java AWT and delivers it to the EPG 1702 (S2805).

On the other hand, in the case where the determination result shows the terrestrial wave broadcasting system (S2804), it converts the key event into an event which can be interpreted by the terrestrial wave navigator GUI 1832 of the terrestrial wave navigator 1705, and delivers it to the terrestrial wave navigator GUI 1832 of the terrestrial wave navigator 1705 (S2806).

With the above-described embodiment, the following effects are obtainable.

A broadcast receiving apparatus, which receives and reproduces broadcast signals of programs which are executed in parallel by plural broadcasting systems to which the programs belong, can seamlessly switch services of plural broadcasting systems and reproduce these services, at the time of selecting a service, by determining a specified channel identifier and distributing the channel identifier to a service reproduction function of a proper broadcasting system when the channel identifier of a second broadcasting system is specified by an electric program guide of a first broadcasting system.

Further, by determining the broadcasting system to which the currently being reproduced service belongs using as the key the channel identifier which is currently being specified in the current library and switching the delivery destinations of the inputted key event at the time of key input, the broadcast receiving apparatus can deliver the key event to the program guide of the broadcasting system to which the currently being reproduced service belongs even in a state where electric program guides of the plural broadcasting systems are being executed in parallel.

### Second Embodiment

Hereafter, an apparatus and a method of a second embodiment of the present invention are described with reference to the drawings.

The hardware configuration, software configuration, various types of data formats of this embodiment are the same as the ones in the first embodiment other than FIG. 18. Therefore, FIG. 1 to FIG. 17, FIG. 19 to FIG. 28 and FIG. 32 to FIG. 34 used in the first embodiment will be used. The constituent elements in these drawings have the same functions as the identical constituent elements in the first embodiment, and therefore descriptions are not repeated.

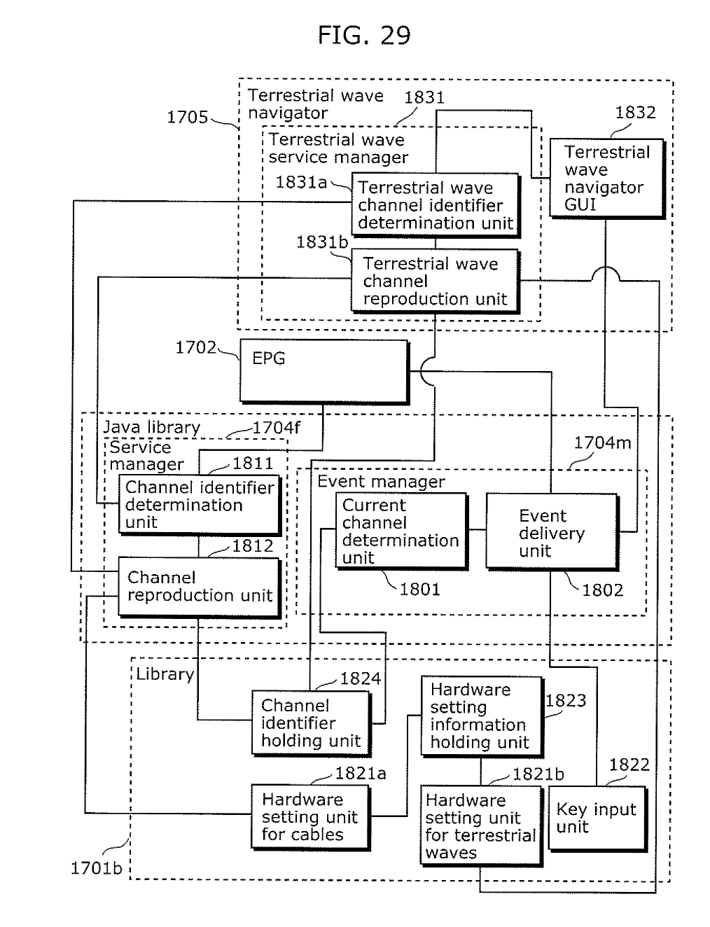

FIG. 29 shows the parts which are closely related to this embodiment, in the configuration of the program which is considered as necessary for service reproduction in the broadcast receiving terminal of this embodiment where the cable television broadcasting system and the terrestrial wave broadcasting system coexist. In FIG. 29, the constituent elements other than the current channel determination unit 1801 have the identical functions as those of the constituent elements in the first embodiment which are provided with the identical names and reference numerals.

In this embodiment, the current channel determination unit 1801 has the identical function as the one in the first embodiment, but only the determination method of broadcasting systems is different. The determination of broadcasting systems is realized according to the following method.

Upon receiving an inquiry from the event delivery unit 1802, the current channel determination unit 1801 makes an inquiry to the hardware setting information holding unit 1823 of the library 1701b in respect to tuning information such as the frequency specified to so the current tuner 1901 and a demodulation method. Subsequently, referring to the guide shown in FIG. 20 held by the library 1701b, it derives the channel identifier corresponding to the tuning information obtained through the inquiry. Further, referring to the list of broadcasting information shown in FIG. 21 held by the library 1701b, it derives the corresponding broadcasting system. Consequently, it determines the one of the cable broadcasting system and the terrestrial wave broadcasting system to which the MPEG-2 transport stream which is currently being in tuning belongs. In this method, the tuning information which is specified to the tuner is the determination basis of the broadcasting system.

With the above-described embodiment, the following effects will be obtained in addition to the effect of being capable of switching services of plural broadcasting systems of the first embodiment and reproducing these services.

A broadcast receiving apparatus, which receives and reproduces broadcast signals of programs which are executed in parallel by plural broadcasting systems to which the programs belong, determines the broadcasting system to which the MPEG-2 transport stream which is in tuning belongs, based on the tuning information which is specified to the current tuner, at the time of key input. Subsequently, by switching the delivery destinations of the inputted key event, the broadcast receiving apparatus can deliver the key event to the electric program guide or the program of the broadcasting system to which the MPEG-2 transport stream which is in tuning belongs, even in a state where electric program guides of the plural broadcasting systems are being executed in parallel.

### Third Embodiment

Hereafter, an apparatus and a method of a third embodiment of the present invention are described with reference to the drawings.

The hardware configuration, software configuration, various types of data formats of this embodiment are the same as the ones in the first embodiment except FIG. 18. Therefore, FIG. 1 to FIG. 17, FIG. 19 to FIG. 28 and FIG. 32 to FIG. 34 used in the first embodiment will be used. The constituent elements in these drawings have the same functions as the identical constituent elements in the first embodiment, and therefore descriptions are not repeated.

FIG. 29 shows the parts which are closely related to this embodiment, in the configuration of the program which is considered as necessary for service reproduction in the broadcast receiving terminal of this embodiment where the cable television broadcasting system and the terrestrial wave broadcasting system coexist. In FIG. 29, the constituent elements other than the current channel determination unit 1801 have the identical functions as those of the constituent elements in the first embodiment which are provided with the identical names and reference numerals.

In this embodiment, the current channel determination unit 1801 has the identical function as the one in the first embodiment, but only the determination method of broadcasting systems is different. The determination of broadcasting systems is realized according to the following method.

Upon receiving an inquiry from the event delivery unit 1802, the current channel determination unit 1801 makes an inquiry to a JMF 1704a in respect to the PID specified to the TS decoder 1902. Subsequently, referring to the guide shown in FIG. 20 held by the library 1701b, it derives the channel identifier corresponding to the PID obtained through the inquiry. Further, referring to the list of broadcasting information shown in FIG. 21 held by the library 1701b, using the channel identifier as the key, it derives the corresponding broadcasting system. With this, it determines the one of the cable broadcasting system and the terrestrial wave broadcasting system to which a PES packet or an MPEG-2 section which is currently being decoded belongs. In this method, the PID which is specified to the TS decoder is the determination basis of the broadcasting system.

Note that the present invention is implementable even in the case of making an inquiry to the hardware setting information holding unit 1823 of the library 1701b in respect to the PID which is currently being specified to the TS decoder 1902 and determining the one of the cable broadcasting system and the terrestrial wave broadcasting system to which a PES packet or an MPEG-2 section which is currently being decoded belongs.

With the above-described embodiment, the following effects will be obtained in addition to the effect of being capable of switching services of plural broadcasting systems of the first embodiment and reproducing these services.

A broadcast receiving apparatus, which receives and reproduces broadcast signals of programs which are executed in parallel by plural broadcasting systems to which the TV show programs belong, can determine the broadcasting system to which the PES packet or the MPEG-2 section which is currently being decode belongs at the time of inputting the key, and deliver the key event to the program guide or the program of the broadcasting system to which the PES packet or the MPEG-2 section which is currently being decoded belongs, even in a state where electric program guides of the plural broadcasting systems are being executed in parallel.

### Fourth Embodiment

Hereafter, an apparatus and a method according to a fourth embodiment of the present invention are described with reference to the drawings.

The hardware configuration, software configuration, various types of data formats of this embodiment are the same as the ones in the first embodiment to the third embodiment. Therefore, FIG. 1 to FIG. 16, FIG. 19 to FIG. 28 and FIG. 32 to FIG. 34 used in the first embodiment to the third embodiment will be used. The constituent elements in these drawings have the same functions as the identical constituent elements in the first embodiment, and therefore descriptions are not repeated.

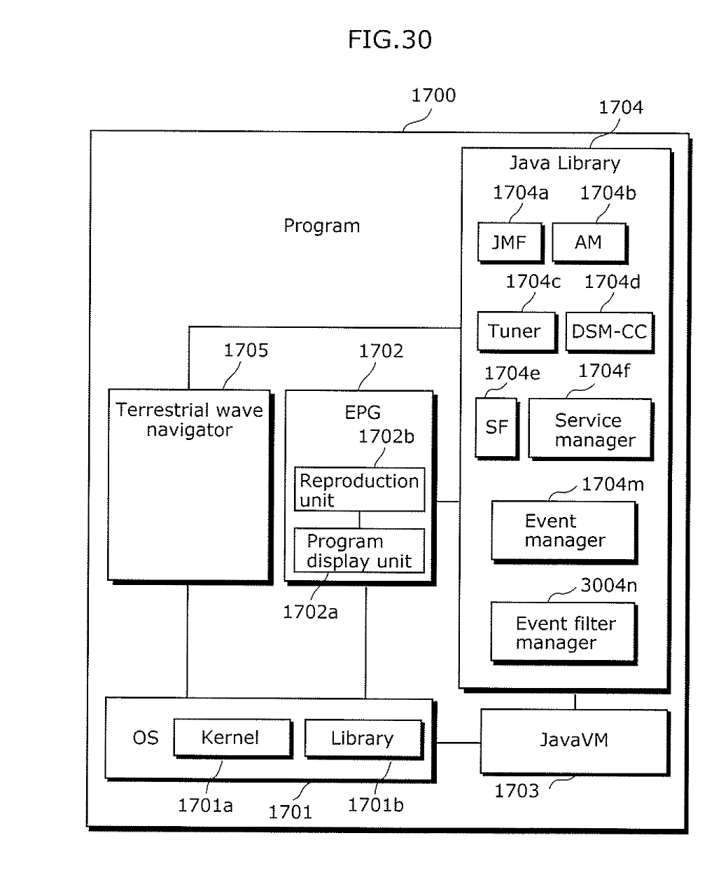

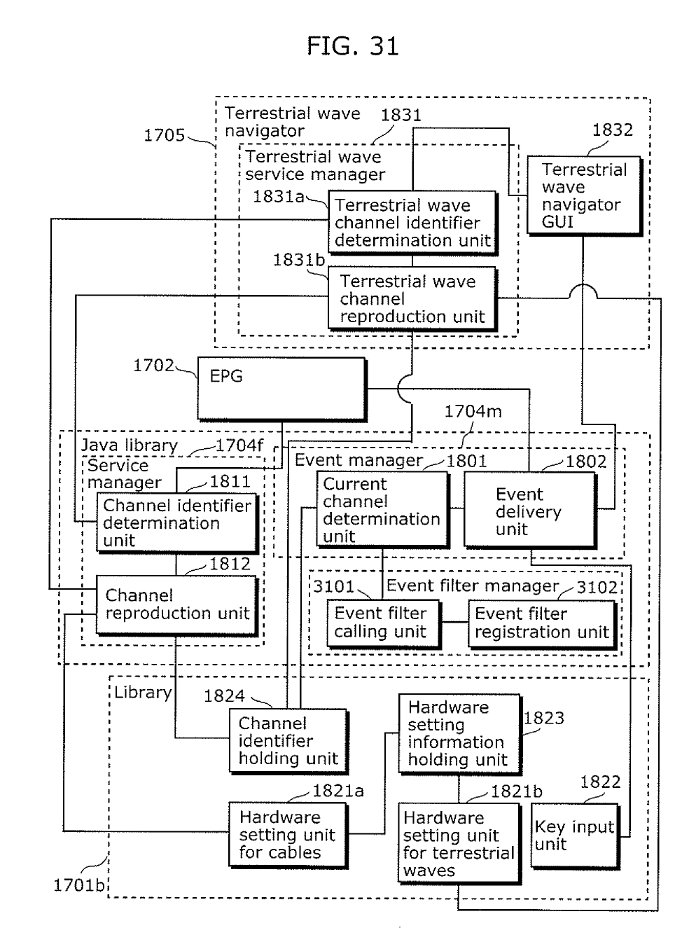

FIGS. 30 and 31 respectively show the configurations of the programs of this embodiment, and the programs are software stored in a ROM 1309. Among the constituent elements shown in these drawings, the constituent elements other than an event manager 1704m and an event filter manager 3004n have the identical functions of the constituent elements of the first embodiment with the identical names and reference numerals, and therefore descriptions are not repeated.

FIG. 30 is a configuration diagram of the program which is considered as necessary for service reproduction in the broadcast receiving terminal of this embodiment where the cable television broadcasting system and the terrestrial wave broadcasting system coexist, and is software recorded into the ROM 1309. Among these constituent elements of FIG. 30, the constituent elements having equivalent functions as the constituent elements of FIG. 17 described in the first embodiment are provided with the identical reference numerals to the ones in FIG. 17, and descriptions are omitted. The Java library 1704 of the program 1700 of FIG. 30 includes these constituent elements of FIG. 17 described in the first embodiment, and further an event filter manager 3004n.

FIG. 31 shows the internal configuration of the event manager 1705m of this embodiment. The event manager 1705m is configured by the current channel determination unit 1801 and the event delivery unit 1802, in a similar manner to the first embodiment.

In this embodiment, the event delivery unit 1802 also has the function of the event delivery unit 1802 described in the first embodiment. In addition to this, it makes an inquiry to the current channel determination unit 1801 in respect to the broadcasting system to which the currently being reproduced service belongs by passing a channel identifier and further the key event.

In this embodiment, upon receiving the inquiry from the event delivery unit 1802, the current channel determination unit 1801 determines the one of the cable broadcasting system and the terrestrial wave broadcasting system to which the currently being reproduced service belongs, and notifies the result to the event delivery unit.

The determination of broadcasting systems by the current channel determination unit 1801 is realized according to the following methods.

Upon receiving the key event from the event delivery unit 1802 and receiving an inquiry from the event delivery unit 1802, the current channel determination unit 1801 makes an inquiry to the channel identifier holding unit 1824 in respect to the channel identifier of the service which has been specified and is currently being reproduced. Subsequently, the current channel determination unit 1801 passes the obtained channel identifier to the later-described event filter manager 3004n and makes an inquiry to it in respect to the broadcasting system to which the currently being reproduced service belongs, that is, the broadcasting system to which the key event should be delivered. The current channel determination unit 1801 regards the result of the inquiry to the event filter manager 3004n as the broadcasting system to which the currently being reproduced service belongs, that is, the broadcasting system to which the key event should be delivered. In third method, the result of the inquiry to the event filter manager 3004n is the determination basis of a broadcasting system.

The event filter manager 3004n receives the channel identifier of the service which is currently being reproduced from the current channel determination unit 1801 at the time of key input, and determines the broadcasting system to which the key input should be delivered using an event filter FIG. 31 shows the internal configuration of the event filter manager 3004n. The event filter manager 3004n is configured by an event filter calling unit 3101 and an event filter registration unit 3102.

The event filter registration unit 3102 provides a Java API for registering event filters. The Java API is represented by setEventFilter (EventFilterf) format, and an event filter is specified to f. When this API is called by the Java program, the specified event filter is stored in the first memory unit 1308.

The event filter is a part of the downloaded Java program, and a program code written in the Java language. The event filter is a method EventFilter filter (Eventevt, Locator 1) having a SystemID as a return value. The SystemIF of the return value is an ID for identifying the broadcasting system which is the delivery destination of the key event. More specifically, for example, it is assumed that the SystemID=1 shows the cable broadcasting system, and the SystemID=2 shows the terrestrial wave broadcasting system. A parameter evt is the key event, and I is the channel identifier. These parameters are communicated from the current channel determination unit 1801 to the event filter calling unit 3101. The event filter which is the downloaded Java program returns the broadcasting system to which the inputted key event is delivered with reference to the information of these parameters.

Note that return value 0 means that the event filter does not particularly specify any broadcasting system to which the key event should be delivered and leaves, to the current channel determination unit 1801, the determination of the broadcasting system to which the key event should be delivered. In third case, the current channel determination unit 1801 makes an inquiry to the channel identifier holding unit in respect to the channel identifier of the service which has been specified and is currently being reproduced, in a similar method to the method of the first embodiment. Referring to the list of broadcasting system information shown in FIG. 21, it determines the one of the cable broadcasting system and the terrestrial wave broadcasting system to which the service is currently being reproduced.

The event filter calling unit 3101 receives the key event passed from the current channel determination unit 1801 and the channel identifier of the service which is being reproduced, from the current channel determination unit 1801. Subsequently, it calls the fiterEvent method of the event filter which has been registered in the first memory unit. Next, it notifies the delivery destination of the key event which is the return value from the event filter to the channel determination unit 1801.

Note that the determination result returned by the event filter manager 3004n is not necessarily the broadcasting system to which the currently being reproduced service belongs. Even in this case, the current channel determination unit 1801 regards the inquiry result of the event filter manager 3004n as the broadcasting system to which the key event should be delivered.

If no event filter has been set in the event manager, the current channel determination unit 1801 makes an inquiry to the channel identifier holding unit 1824 in respect to the channel identifier of the service which has been specified and currently being reproduced, in a similar method as the method of the first embodiment. Referring to the list of broadcasting system information shown in FIG. 21, it determines the one of the cable broadcasting system and the terrestrial broadcasting system to which the currently being reproduced service belongs.

With the above-described embodiment, the following effects will be obtained in addition to the first embodiment.

A broadcast receiving apparatus, which receives and reproduces broadcast signals of programs which are executed in parallel by plural broadcasting systems to which the programs belong, can determine the broadcasting system to which the key event should be delivered at the time of key input, and deliver the key event to the electric program guide or the program of the broadcasting system following the filter registered by the Java program, even in a state where electric program guides of the plural broadcasting systems are being executed in parallel. A particularly obtained effect is that the Java program can forcedly switch the key delivery destinations independent from the service which is currently being reproduced and the MPEG transport stream which is in tuning.

In the above-described embodiment, variations maintaining the above effects are conceivable.

It has been described that the current channel determination unit 1801 makes an inquiry to the channel identifier holding unit in respect to the channel identifier of the service which is being reproduced, passes the key event and the obtained channel identifier to the event filter calling unit 3101 so as to obtain the determination result. However, for example, a method of making an inquiry by passing other parameters to the event filter calling unit 3101 may be used as long as the information is suffice to determine the broadcasting system which is the delivery destination. The present invention is implementable using another method where the current channel determination unit 1801 obtains the determination result by not making any inquiry to the channel identifier holding unit in respect to the channel identifier of the currently being reproduced service but passing only the key event to the event filter calling unit 3101, and the event filter has a method EventFilter. filter (Eventevt) having the delivery destination of the key event as the return value.

Additionally, in the case where the return value is 0, the system may be configured to determine the one of the cable broadcasting system and the terrestrial wave broadcasting system to which the currently being reproduced service belongs, in a similar method to the method of the second embodiment or the method of the third embodiment.

The several embodiments described up to this point show implementation examples of the present invention, and other implementation examples are implementable as long as the essence of the present invention can be realized.

It has been described in the above embodiments that the current channel determination unit 1801 determines the broadcasting system to which the currently being reproduced service belongs at the time of key input and the event delivery unit 1802 switches the delivery destinations of the inputted key event. However, it should be noted that the present invention is applicable even in the case where the delivery destinations which are determined by the current channel determination unit 1801 as switching targets and which are switched by the event delivery unit 1802 are delivery destinations of arbitrary events and allocation destinations of arbitrary resources, not only the delivery destinations of the key event.

In the embodiments described above, the current channel determination unit determines whether the service which is currently being reproduced is the service of the cable broadcasting or the service of the terrestrial wave broadcasting, independently from the operation of the channel identifier determination unit. However, the system may be configured so that the current channel determination unit uses, in stead of this, the determination result of the channel identifier determination unit. In other words, the determination result of the channel identifier determination unit is temporarily saved, and the current channel determination unit reads out this and regards this as the determination result.

These embodiments show the configurations for cable broadcasting systems, but the present invention is independent from types of broadcasting systems. For example, the present invention is easily applicable for a satellite system, a terrestrial wave system, a TV show program delivery system using an IP network or the like. Further, the present invention has no direct relationship to differences between the respective broadcasting systems, it is applicable to an arbitrary transmission medium regardless of the broadcasting system. The present invention is also applicable regardless of whether the system is a wired or wireless system.

It is not necessary for the AV decoder to decode video and audio at the same time. The present invention is implementable even if the AV decoder is configured as separate video and audio decoders. In addition, the AV decoder may have a decoding function for data such as closed captioning and the like.

In the embodiments, an example is provided in which an adapter which controls a conditional access system has been introduced, but the adapter is not always necessary for the implementation of the present invention. The adapter may be of any format, and a configuration without the adapter is also possible. In such a case, in FIG. 15, the MPEG-2 transport stream from the tuner is inputted directly into the TS decoder. The present invention is applicable in such a case as well. In addition, release of the conditional access system by the adapter does not necessarily have to be carried out before the TS decoder. A configuration in which the adapter is in an arbitrary position and is used to release the conditional access system is easily implementable, and the present invention is applicable in such a case as well.

The display and the speaker may be contained within the broadcast receiving apparatus, or an external display and speaker may be connected to the broadcast receiving apparatus. The present invention is applicable regardless of the locations and numbers of the display and speaker.

The present invention is implementable even if the CPU itself is a system which performs the processes of one or all of TS decoding and AV decoding.

Some of the Java virtual machines translate the bytecodes into an executable form which is interpretable by the CPU and pass the resultant to the CPU, which executes it; the present invention is applicable in such a case as well.

It has been described in these embodiments that a program downloaded from a transport stream is executed. However, methods such as starting a program pre-recorded in a ROM, starting a program downloaded and stored in the second memory unit are conceivable.

The DSMCC file system and the recording format of the AIT file may be arbitrary.

The present invention can be implemented even in the case of combining a method of filtering and obtaining AIT sections from an MPEG-2 transport stream with a method of recording the DSMCC sections in a file in a unique format. In addition, the present invention is implementable even in the case of combining a method of filtering and obtaining DSMCC sections from the MPEG-2 transport stream with a method of recording the AIT section in a file in a unique format.

It is assumed in those described embodiments that the terminal apparatus receives broadcasting signals of both the cable broadcasting system and the terrestrial wave broadcasting system, and that these broadcasting signals of both the cable broadcasting system and the terrestrial broadcasting system can be received and reproduced by a single common hardware configuration. However, the terminal apparatus may prepare two separate hardware configurations of the hardware configuration for the cable broadcasting system and the hardware configuration for the terrestrial wave broadcasting system.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A broadcast receiving apparatus of the present invention is highly likely to be used in the consumer apparatus industry relating to broadcast receiving apparatuses. For example, the present invention is applicable to a cable STB, a digital TV, and the like. Furthermore, the present invention is also applicable in devices with a broadcast receiving function, for example, a mobile phone and the like.

What is claimed is:

1. A broadcast content reproducing apparatus which reproduces respective contents compliant with a plurality of broadcast specifications which are different from each other, said apparatus comprising:
a plurality of reproduction environments which are ready, in parallel, to respectively reproduce the contents different from each other;
a first reproduction environment identification unit operable to identify a reproduction environment which is reproducing a content, from among said plurality of reproduction environments; and
a delivery unit operable to deliver key input information indicating details of an instruction to said reproduction environment identified by said first reproduction environment identification unit.

2. The broadcast content reproducing apparatus according to claim 1, further comprising:
a selection unit operable to select a content among the contents compliant with the plurality of broadcast specifications;
a second reproduction environment identification unit operable to identify a reproduction environment which is capable of reproducing the content selected by said selection unit, from among said plurality of reproduction environments; and
a reproduction environment setting unit operable to cause said reproduction environment identified by said second reproduction environment identification unit, to reproduce the content selected by said selection unit.

3. The broadcast content reproducing apparatus according to claim 2,
wherein, said second reproduction environment identification unit is operable to identify, by referring to a table which respectively associates the plurality of broadcast specifications with a plurality of content identifiers for identifying the respective contents, a reproduction environment, among said reproduction environments, which is associated with a content identifier, among the content identifiers, for identifying the content selected by said selection unit.

4. The broadcast content reproducing apparatus according to claim 1, further comprising
an obtainment unit operable to obtain a piece of tuning information indicating a frequency which is currently being applied to reproduction of a content,
wherein, said first reproduction environment identification unit is operable to identify, by referring to a table which respectively associates the plurality of broadcast specifications with pieces of tuning information respectively indicating frequencies, a reproduction environment, among said reproduction environments compliant with broadcasting specifications, which is associated with the piece of tuning information obtained by said obtainment unit.

5. The broadcast content reproducing apparatus according to claim 1, further comprising
an obtainment unit operable to obtain a piece of decoding information indicating a packet identifier which is currently being applied to reproduction of a content,
wherein, said first reproduction environment identification unit is operable to identify, by referring to a table which respectively associates the plurality of broadcast specifications with pieces of decoding information respectively indicating packet identifiers, a reproduction environment, among said reproduction environments compliant with broadcasting specifications, which is associated with the piece of decoding information obtained by said obtainment unit.

6. The broadcast content reproducing apparatus according to claim 1, further comprising
an obtainment unit operable to obtain a content identifier for identifying a content which is being reproduced,
wherein, said first reproduction environment identification unit is operable to identify, by referring to a table which respectively associates the plurality of broadcast specifications with a plurality of content identifiers for respectively identifying the contents, a reproduction environment, among said reproduction environments compliant with broadcasting specifications, which is associated with the content identifier obtained by said obtainment unit.

7. The broadcast content reproducing apparatus according to claim 1, further comprising
a delivery destination identification unit operable to identify a reproduction environment to which the key input information is delivered from among said reproduction environments, based on an execution result of a downloaded program,
wherein said delivery unit is operable to deliver the key input information to said reproduction environment identified by said delivery destination identification unit.

8. A broadcast content reproducing apparatus which reproduces respective contents compliant with a plurality of broadcast specifications which are different from each other, said apparatus comprising:
a plurality of reproduction environments which are ready, in parallel, to respectively reproduce the contents different from each other;
a selection unit operable to select a content among the contents compliant with the plurality of broadcast specifications;
a reproduction environment identification unit operable to identify, among said plurality of reproduction environments, a reproduction environment which is capable of reproducing the content selected by said selection unit from; and
a reproduction environment setting unit operable to cause said reproduction environment identified by said reproduction environment identification unit to reproduce the content selected by said selection unit.

9. A broadcast content reproduction method of reproducing respective contents compliant with a plurality of broadcast specifications which are different from each other, comprising:
identifying a reproduction environment which is reproducing a content, from among the plurality of reproduction environments which are ready, in parallel, to respectively reproduce the contents different from each other; and
delivering key input information indicating details of an instruction to the reproduction environment identified in said identifying.

10. A program intended for reproducing respective contents compliant with a plurality of broadcast specifications which are different from each other, said program causing a computer to execute:
identifying a reproduction environment which is reproducing a content, from among the plurality of reproduction environments which are ready, in parallel, to respectively reproduce the contents different from each other; and
delivering key input information indicating details of an instruction to the reproduction environment identified in the identifying.
